(19) United States
(12) Patent Application Publication
(10) Pub. No.: US 2017/0147919 A1
(43) Pub. Date: May 25, 2017

(54) ELECTRONIC DEVICE AND OPERATING METHOD THEREOF

(71) Applicant: SAMSUNG ELECTRONICS CO., LTD., Suwon-si (KR)

(72) Inventors: Hae-Jun LEE, Suwon-si (KR); Ji-Hyun RHO, Seoul (KR); Deok-Ho KIM, Seoul (KR)

(21) Appl. No.: 15/360,102

(22) Filed: Nov. 23, 2016

(30) Foreign Application Priority Data
Nov. 24, 2015 (KR) 10-2015-0165070
Aug. 23, 2016 (KR) 10-2016-0107179

(51) Int. Cl. G06N 3/00; G06N 99/00; G06F 17/30

(52) U.S. Cl. CPC G06N 3/006; G06F 17/30684; G06N 99/005

(57) ABSTRACT

A method of operating an electronic device according to various example embodiments of the present disclosure may include: acquiring a plurality of text messages; acquiring a keyword corresponding to the plurality of text messages by analyzing each of the plurality of text messages; transmitting a query including the keyword; and performing an operation corresponding to an analysis result of the keyword after receiving the analysis result of the keyword.

### CROSS-REFERENCE TO RELATED APPLICATION

This application is based on and claims priority under 35 U.S.C. §119 to Korean Application Serial Nos. 10-2015-0165070 and 10-2016-0107179, which were filed in the Korean Intellectual Property Office on Nov. 24, 2015 and Aug. 23, 2016, respectively, the contents of which are incorporated by reference herein in their entireties.

### TECHNICAL FIELD

The present disclosure relates generally to an electronic device and an operating method thereof, and for example, to an electronic device that processes an acquired text and an operating method thereof.

### BACKGROUND

Recently, programs or algorithms that are capable of analyzing a voice uttered by a user or a text input by a user to capture user intent have been actively developed. For example, conventional programs or algorithms are capable of converting an input user voice into text and performing natural language processing on the text. Natural language processing may be an artificial intelligence technology that covers the understanding, generation, and analysis of human language and may be used to understand the role of each component in a text. In addition, a separate user intent analysis algorithm analyzes a natural language processing result to analyze natural language included in a text. A conventional electronic device may analyze, for example, a text separated by one sentence, may identify user intent, and may perform an operation corresponding to the identified user intent. However, the conventional electronic device is capable of analyzing user intent only when a text separated by one sentence includes a clear referent, and thus has difficulty in identifying accurate user intent.

### SUMMARY

The present disclosure is provided to address the foregoing problem or other problems, and various example embodiments of the present disclosure may provide an electronic device and an operation method thereof that are capable of analyzing a plurality of texts to more clearly capture user intent and to perform a corresponding operation.

A method of operating an electronic device according to various example embodiments of the present disclosure may include: acquiring a plurality of text messages; acquiring a keyword corresponding to the plurality of text messages by analyzing each of the plurality of text messages; transmitting a query including the keyword to an external device; and performing an operation corresponding to an analysis result of the keyword after receiving the analysis result of the keyword.

An electronic device according to various example embodiments of the present disclosure may include: a communication module comprising communication circuitry; a processor comprising processing circuitry that is electrically connected to the communication module; and a memory that is electronically connected to the processor, wherein the memory may store instructions which, when executed by the processor, cause the processing circuitry of the processor to acquire a plurality of text messages, to acquire a keyword corresponding to the plurality of text messages by analyzing each of the plurality of text messages, to transmit a query including the keyword to an external device using the communication circuitry of the communication module, and to perform an operation corresponding to an analysis result of the keyword after receiving the analysis result of the keyword.

A method of operating an electronic device according to various example embodiments of the present disclosure may include: displaying, on a display, an execution screen of a chat application running in the electronic device; displaying, on the execution screen, a plurality of text messages received from another electronic device through communication circuitry of a communication unit and a plurality of text messages input through input circuitry of an input unit of the electronic device; determining an external device that is capable of providing information based on at least one of the plurality of text messages displayed on the execution screen; receiving information from the determined external device; and displaying the received information on the display. The plurality of text messages displayed on the execution screen and the received information may be chronologically arranged and displayed on the execution screen. A user interface (UI) element that is capable of receiving an input (e.g., a user input) may be displayed on the execution screen.

According to various example embodiments of the present disclosure, there may be provided an electronic device and an operation method thereof that are capable of analyzing a plurality of texts to more clearly capture the intent of a user or a plurality of users and to perform a corresponding operation. Accordingly, when a plurality of texts occurs in a conversation between a plurality of users, the intents of the plurality of users may be more clearly identified. Further, when a single user utters or inputs a plurality of texts at intervals, the intent of the user may also be more clearly identified.

### BRIEF DESCRIPTION OF THE DRAWINGS

The above and other aspects, features, and advantages of the present disclosure will be more apparent from the following detailed description, taken in conjunction with the accompanying drawings, in which like reference numerals refer to like elements, and wherein:

FIG. 1 is a block diagram illustrating an example electronic device and a network according to various example embodiments of the present disclosure;

FIG. 2 is a block diagram illustrating an example electronic device according to various example embodiments;

FIG. 3 is a block diagram illustrating an example program module according to various example embodiments;

FIG. 4 is a flowchart illustrating an example method of operating an electronic device according to various example embodiments of the present disclosure;

FIG. 5A and FIG. 5B are diagrams illustrating an example electronic device according to various example embodiments of the present disclosure;

FIG. 6 is a diagram illustrating example acquisition of a text message according to various example embodiments of the present disclosure;

FIG. 7A and FIG. 7B are flowcharts illustrating an example method of operating an electronic device according to various example embodiments of the present disclosure;

FIG. 8A is a diagram illustrating example natural language analysis by an electronic device according to various example embodiments of the present disclosure;

FIG. 8B is a diagram illustrating an example template according to various example embodiments of the present disclosure;

FIG. 8C is a diagram illustrating an example result of applying a machine learning or deep learning algorithm to a pattern by user intent according to various example embodiments of the present disclosure;

FIG. 9 is a flowchart illustrating an example method of operating an electronic device according to various example embodiments of the present disclosure;

FIG. 10A is a diagram illustrating an example electronic device according to various example embodiments of the present disclosure;

FIG. 10B is a diagram illustrating example generation of a keyword according to various example embodiments of the present disclosure;

FIG. 10C is a diagram illustrating an example electronic device according to various example embodiments of the present disclosure;

FIG. 10D is a diagram illustrating an example process of generating a keyword according to various example embodiments of the present disclosure;

FIG. 11 is a flowchart illustrating an example method of operating an electronic device according to various example embodiments of the present disclosure;

FIG. 12A and FIG. 12B are flowcharts illustrating an example method of operating an electronic device according to various example embodiments of the present disclosure;

FIG. 13 is a diagram illustrating an example electronic device according to various example embodiments of the present disclosure;

FIG. 14 is a diagram illustrating an example receiver server according to various example embodiments of the present disclosure;

FIG. 15 is a flowchart illustrating an example method of operating an electronic device according to various example embodiments of the present disclosure;

FIG. 16A, 16B and FIG. 16C are flowcharts illustrating example generation of a keyword further using additional information according to various example embodiments of the present disclosure;

FIG. 17A, 17B, 17C and FIG. 17D are diagrams illustrating example generation of a keyword further using additional information according to various example embodiments of the present disclosure;

FIG. 18 is a diagram illustrating an example operation of an electronic device in an Internet of Things (IoT) environment according to various example embodiments of the present disclosure;

FIG. 19 is a flowchart illustrating an example method of operating an electronic device according to various example embodiments of the present disclosure;

FIG. 20 is a flowchart illustrating an example method of operating an electronic device according to various example embodiments of the present disclosure;

FIG. 21A and FIG. 21B are diagrams illustrating an example process of processing a user voice from a single user according to various example embodiments of the present disclosure;

FIG. 22 is a flowchart illustrating an example method of operating an electronic device according to various example embodiments of the present disclosure;

FIG. 23 is a diagram illustrating an example operation of an electronic device according to various example embodiments of the present disclosure;

FIG. 24 is a flowchart illustrating an example method of operating an electronic device according to various example embodiments of the present disclosure; and

FIG. 25A, 25B and FIG. 25C are diagrams illustrating an example case in which an electronic device invokes an indoor IoT device and communicates therewith according to various example embodiments of the present disclosure.

### DETAILED DESCRIPTION

Hereinafter, various example embodiments of the present disclosure will be described with reference to the accompanying drawings. However, it should be understood that there is no intent to limit the present disclosure to the particular forms disclosed herein; rather, the present disclosure should be understood to cover various modifications, equivalents, and/or alternatives of the various example embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude the existence of one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various example embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. On the other hand, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of according to the situation. The term “configured to” may not necessarily imply “specifically designed to” in hardware. In some situations, the expression “device configured to” may refer, for example, to a situation in which the device, together with other devices or components, “is able to”. For example, the phrase “processor adapted (or configured) to perform A, B, and C” may refer, for example, to various processing circuitry, including, such as, for example, and without limitation, a dedicated processor (e.g., embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing various example embodiments and are not intended to limit the scope of other example embodiments. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even where the term is defined in the present disclosure should not be interpreted to exclude embodiments of the present disclosure.

An electronic device according to various example embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device, or the like, but is not limited thereto. According to various example embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit), or the like, but is not limited thereto. In addition, the electronic device may wirelessly receive power from a wireless power transmitter and thus may be called wireless power receiver.

According to some example embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame, or the like, but is not limited thereto.

According to another example embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.), or the like, but is not limited thereto.

According to some example embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter), or the like, but is not limited thereto. In various example embodiments, the electronic device may be a combination of one or more of the aforementioned various devices. According to some example embodiments, the electronic device may also be a flexible device. Further, the electronic device according to an example embodiment of the present disclosure is not limited to the aforementioned devices, and may include a new electronic device according to the development of technology.

Hereinafter, an electronic device according to various example embodiments will be described with reference to the accompanying drawings. In the present disclosure, the term “user” may indicate a person using an electronic device or a device (e.g., an artificial intelligence electronic device) using an electronic device.

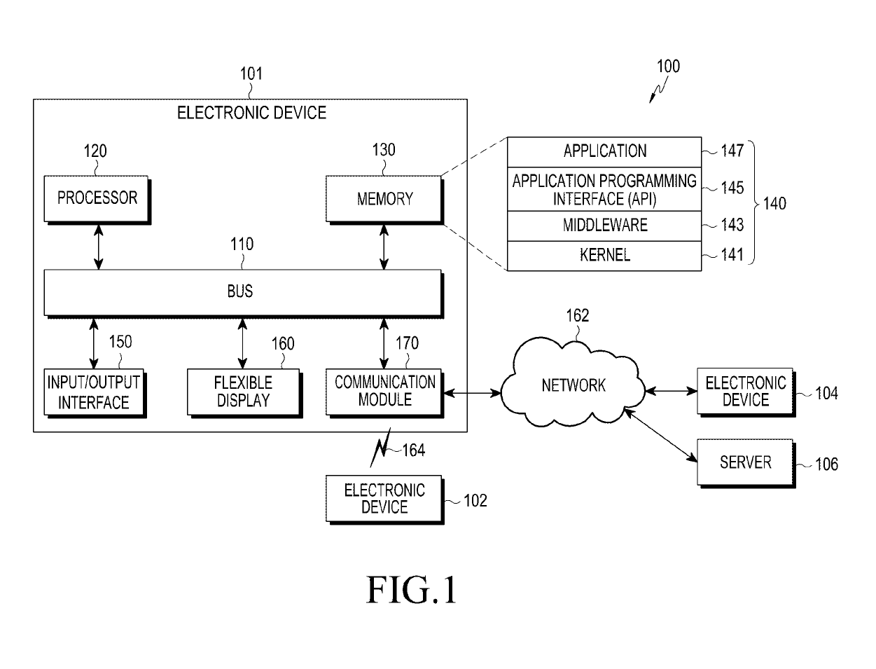

An electronic device 101 in a network environment 100 according to various example embodiments is described with reference to FIG. 1. The electronic device 101 may include a bus 110, a processor (e.g., including processing circuitry) 120, a memory 130, an input/output interface (e.g., including input/output circuitry) 150, a display 160, and a communication module (e.g., including communication circuitry) 170. In some example embodiments, at least one of the components may be omitted or an additional component may be further included in the electronic device 101.

The bus 110 may include, for example, a circuit that connects the components 110 to 170 to each other and delivers communications (for example, control messages and/or data) between the components.

The processor 120 may include various processing circuitry, such as, for example, and without limitation, one or more of a central processing unit (CPU), an application processor (AP), and a communication processor (CP). The processor 120 may control, for example, at least one different component of the electronic device 101 and/or may perform an operation relating to communication or data processing.

The memory 130 may include a volatile and/or nonvolatile memory. The memory 130 may store, for example, a command or data related to at least one different component of the electronic device 101. According to an example embodiment, the memory 130 may store software and/or a program 140. The program 140 may include, for example, a kernel 141, middleware 143, an application programming interface (API) 145, and/or an application program (or “application”) 147. At least part of the kernel 141, the middleware 143, and the API 145 may be designated as an operating system (OS).

The kernel 141 may control or manage system resources (for example, the bus 110, the processor 120, the memory 130, or the like) used to perform an operation or function implemented in other programs (for example, the middleware 143, the API 145, or the application program 147). Further, the kernel 141 may provide an interface that allows the middleware 143, the API 145, or the application program 147 to access an individual component of the electronic device 101 to thereby control or manage the system resources.

The middleware 143 may serve as a relay so that, for example, the API 145 or the application program 147 communicates with the kernel 141 to exchange data.

Further, the middleware 143 may process one or more requests for operations received from the application program 147 according to priority. For example, the middleware 143 may assign at least one application program 147 a priority for using a system resource (for example, the bus 110, the processor 120, the memory 130, or the like) of the electronic device 101. The middleware 143 may process the one or more requests for operations according to the priority assigned to the at least one application program, thereby performing scheduling or load balancing for the one or more requests for operations.

The API 145 is, for example, an interface for the application 147 to control a function provided from the kernel 141 or the middleware 143 and may include, for example, at least one interface or function (for example, a command) for file control, window control, image processing, or text control.

The input/output interface 150 may include various input/output circuitry configured to serve as an interface that delivers a command or data, which is input from, for example, a user or different external device, to a different component(s) of the electronic device 101. Further, the input/output interface 150 may output a command or data, which is received from a different component(s) of the electronic device 101, to the user or different external device.

The display 160 may include, for example, a liquid crystal display (LCD), a light emitting diode (LED) display, an organic light emitting diode (OLED) display, a microelectromechanical systems (MEMS) display, and an electronic paper display, or the like, but is not limited thereto. The display 160 may display, for example, various types of content (for example, a text, an image, a video, an icon, a symbol, or the like) for the user. The display 160 may include a touch screen and may receive touch, gesture, proximity, or hovering inputs using, for example, an electronic pen or a user body part.

The communication module 170 may include various communication circuitry configured to establish communication, for example, between the electronic device 101 and an external device (for example, a first external electronic device 102, a second external electronic device 104, or a server 106). For example, the communication module 170 may be connected to a network 162 via wireless communication or wire-based communication to communicate with the external device (for example, the second external electronic device 104 or the server 106).

The wireless communication may use, for example, a cellular communication protocol, which may be ,for example, at least one of Long-Term Evolution (LTE), LTE-Advanced (LTE-A), code division multiple access (CDMA), wideband CDMA (WCDMA), universal mobile telecommunications system (UMTS), Wireless Broadband (WiBro), and Global System for Mobile Communications (GSM). Further, the wireless communication may include, for example, short-range communication 164. The short-range communication 164 may include, for example, at least one of Wireless Fidelity (Wi-Fi), Bluetooth, Near Field Communication (NFC), and global navigation satellite system (GNSS). The GNSS may include, for example, at least one of a global positioning system (GPS), a global navigation satellite system (Glonass), a Beidou navigation satellite system (hereinafter, “Beidou”), and Galileo, which is the European global satellite-based navigation system, depending on a use area or bandwidth. In the present disclosure, “GPS” may be interchangeably used with “GNSS” hereinafter. The wire-based communication may include, for example, at least one of universal serial bus (USB), high definition multimedia interface (HDMI), recommended standard 232 (RS-232), and plain old telephone service (POTS). The network 162 may include a telecommunications network, which may be, for example, at least one of a computer network (for example, a local area network (LAN) or wide area network (WAN)), the Internet, and a telephone network.

The first and second external electronic devices 102 and 104 may each be a device of a type that is the same as, or different from, the electronic device 101. According to an example embodiment, the server 106 may include a group of one or more servers. According to various example embodiments, all or part of the operations performed in the electronic device 101 may be performed in another electronic device or a plurality of electronic devices (for example, the electronic devices 102 and 104 or the server 106). According to an example embodiment, when the electronic device 101 needs to perform a function or service automatically or by request, the electronic device 101 may request another electronic device (for example, the electronic device 102 or 104, or the server 106) to perform at least some functions related to the function or service, instead of, or in addition to, autonomously performing the function or service. The other electronic device (for example, the electronic device 102 or 104, or the server 106) may perform the requested functions or additional function and may transmit the result to the electronic device 101. The electronic device 101 may provide the requested function or service by using the same received result or additionally processing the result. To this end, cloud computing, distributed computing, or client-server computing technologies may be used.

In various example embodiments of the present disclosure, the memory 130 may store an instruction for the processor 120, upon execution, to acquire a plurality of text messages, to acquire a keyword corresponding to the plurality of text messages by analyzing each of the plurality of text messages, to transmit a query to an external device including the keyword using the communication module 170, and to perform an operation corresponding to an analysis result of the keyword after receiving the analysis result of the keyword.

In various example embodiments of the present disclosure, the memory 130 may store an instruction for the processor 120, upon execution, to acquire receiver information on a receiver that performs a keyword analysis and to transmit the query including the keyword and the receiver information using the communication module, and the keyword analysis may be performed by an electronic device corresponding to the receiver information.

In various example embodiments of the present disclosure, the memory 130 may store an instruction for the processor 120, on execution, to perform natural language processing on each of the plurality of text messages and to generate the keyword using a natural language processing result of each of the plurality of text messages.

In various example embodiments of the present disclosure, the memory 130 may store an instruction for the processor 120, upon execution, to compare a preset template with the natural language processing result and to generate the keyword based on a comparison result.

In various example embodiments of the present disclosure, the memory 130 may store an instruction for the processor 120, upon execution, to apply a machine learning, artificial intelligence or deep learning algorithm to the natural language processing result, to determine intent of each of the plurality of text messages based on an application result, and to generate the keyword based on the intent of each of the plurality of text messages.

In various example embodiments of the present disclosure, the memory 130 may store an instruction for the processor 120, on execution, to acquire a plurality of first text messages in a first period and to acquire a plurality of second text messages in a second period.

In various example embodiments of the present disclosure, the memory 130 may store an instruction for the processor 120, upon execution, to generate a first keyword corresponding to the plurality of first text messages and to generate a second keyword corresponding to the plurality of second text messages.

In various example embodiments of the present disclosure, the memory 130 may store an instruction for the processor 120, upon execution, to generate the second keyword using an analysis result of the plurality of second text messages and at least one of the first keyword and the plurality of first text messages.

In various example embodiments of the present disclosure, the memory 130 may store an instruction for the processor 120, upon execution, to acquire additional information and to generate the keyword using an analysis result of the plurality of text messages and the additional information.

In various example embodiments of the present disclosure, the memory 130 may store an instruction for the processor 120, upon execution, to acquire additional information associated with the analysis result of the plurality of text messages or to acquire independent additional information from the plurality of text messages.

In various example embodiments of the present disclosure, the electronic device 101 may further include a microphone (not shown) that acquires a plurality of user voices, and the memory 130 may store an instruction for the processor 120, upon execution, to acquire the plurality of text messages by converting the plurality of user voices acquired from the microphone.

In various example embodiments of the present disclosure, the display 160 may display an execution screen of a chat application running in the electronic device. The memory 130 may store an instruction to control the processor 120, upon execution, to display a plurality of text messages, which is input to the electronic device 101 or received from another electronic device, on the execution screen of the chat application, to receive an analysis request for the plurality of text messages, to transmit a keyword corresponding to the plurality of text messages through the communication circuitry of the communication module 170 upon the analysis request, and to receive an analysis result of the keyword and displaying the received analysis result of the keyword on the execution screen of the chat application.

In various example embodiments of the present disclosure, the memory 130 may store an instruction for the processor 120, upon execution, to acquire a plurality of text messages, to acquire a keyword corresponding to the plurality of text messages by analyzing each of the plurality of text messages, and to perform an operation corresponding to the keyword.

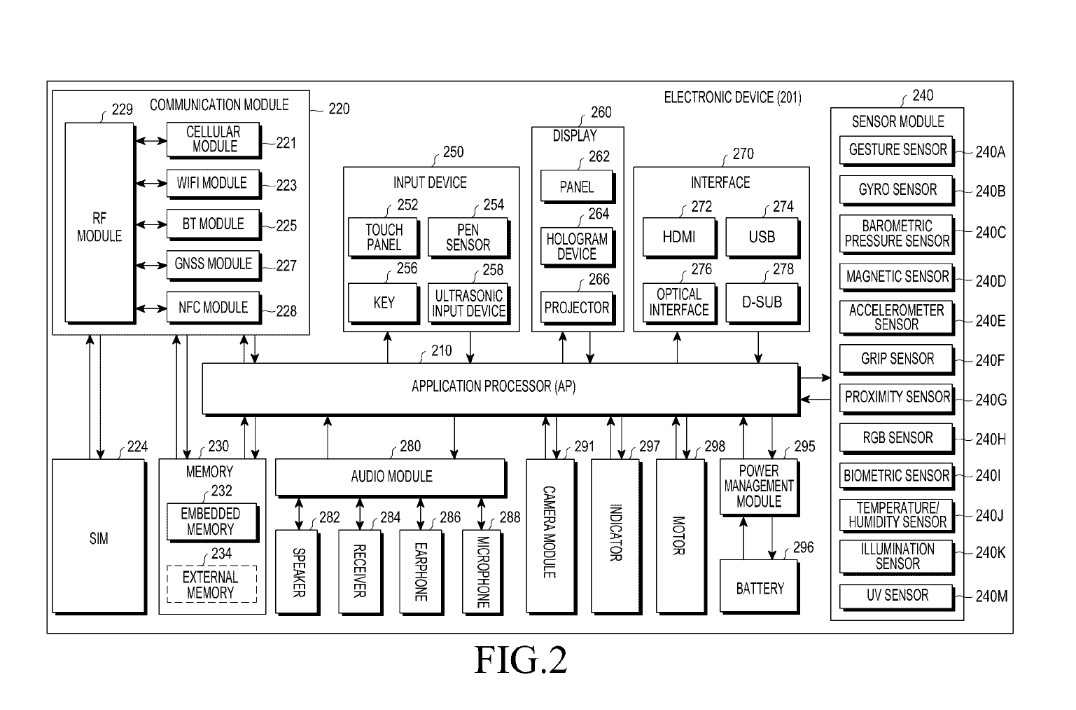

FIG. 2 is a block diagram illustrating an example electronic device 201 according to various example embodiments. The electronic device 201 may include, for example, the whole or part of the electronic device 101 illustrated in FIG. 1. The electronic device 201 may include one or more processors (for example, APs) (e.g., including processing circuitry) 210, a communication module (e.g., including communication circuitry) 220, a subscriber identification module (SIM) 224, a memory 230, a sensor module 240, an input device (e.g., including input circuitry) 250, a display 260, an interface (e.g., including interface circuitry) 270, an audio module 280, a camera module 291, a power management module 295, a battery 296, an indicator 297, and a motor 298.

The processors 210 may include various processing circuitry configured to run, for example, an OS or an application program to control a plurality of hardware or software components that are connected to the processors 210 and may perform various kinds of data processing and operations. The processors 210 may be configured, for example, as various processing circuitry (e.g., including a CPU), a system on chip (SoC), or the like, but is not limited thereto. According to an example embodiment, the processors 210 may further include a graphic processing unit (GPU) and/or an image signal processor. The processors 210 may include at least part (for example, a cellular module 221) of the components illustrated in FIG. 2. The processors 210 may load a command or data received from at least one of other components (for example, a nonvolatile memory) into a volatile memory to process the command or data and may store various kinds of data in the nonvolatile memory.

The communication module 220 may have a configuration that is the same as, or similar to, that of the communication module 170 in FIG. 1. The communication module 220 may include, various communication circuitry including, for example, and without limitation, a cellular module 221, a Wi-Fi module 223, a Bluetooth module 225, a global navigation satellite system (GNSS) module 227 (for example, a global positioning system (GPS) module, a Glonass module, a Beidou module, or a Galileo module), a near field communication (NFC) module 228, and a radio frequency (RF) module 229.

The cellular module 221 may provide, for example, a voice call, a video call, a text messaging service, or an Internet service through a communication network. According to an example embodiment, the cellular module 221 may perform identification and authentication of the electronic device 201 in a communication network using the SIM (for example, an SIM card) 224. According to an example embodiment, the cellular module 221 may perform at least part of the functions provided by the processors 210. According to an example embodiment, the cellular module 221 may include a communication processor (CP).

The Wi-Fi module 223, the Bluetooth module 225, the GNSS module 227, and the NFC module 228 may each include a processor to process data transmitted and received via the respective modules. According to an example embodiment, at least part (for example, two or more) of the cellular module 221, the Wi-Fi module 223, the Bluetooth module 225, the GNSS module 227, and the NFC module 228 may be included in one integrated circuit (IC) or IC package.

The RF module 229 may transmit and receive, for example, a communication signal (for example, an RF signal). The RF module 229 may include, for example, a transceiver, a power amplifier (amp) module (PAM), a frequency filter, a low noise amplifier (LNA), an antenna, or the like. According to another example embodiment, at least one of the cellular module 221, the Wi-Fi module 223, the Bluetooth module 225, the GNSS module 227, and the NFC module 228 may transmit and receive an RF signal through a separate RF module.

The SIM 224 may include, for example, a card including an SIM and/or an embedded SIM and may include unique identification information (for example, an integrated circuit card identifier (ICCID)) or subscriber information (for example, an international mobile subscriber identity (IMSI)).

The memory 230 (for example, a memory 130) may include, for example, an internal memory 232 or an external memory 234. The internal memory 232 may include, for example, at least one of a volatile memory (for example, a dynamic random-access memory (DRAM), a static RAM (SRAM), a synchronous dynamic RAM (SDRAM), or the like) and a nonvolatile memory (for example, a one-time programmable read-only memory (OTPROM), a programmable ROM (PROM), an erasable and programmable ROM (EPROM), an electrically erasable and a programmable ROM (EEPROM), a mask ROM, a flash ROM, a flash memory (for example, an NAND flash, an NOR flash, or the like), a hard drive, or a solid state drive (SSD)).

The external memory 234 may further include a flash drive, for example, a compact flash (CF), a secure digital (SD), a micro secure digital (micro-SD), a mini secure digital (mini-SD), an extreme digital (xD), a multi-media card (MMC), a memory stick, or the like. The external memory 234 may be functionally and/or physically connected to the electronic device 201 through various interfaces.

The sensor module 240 may measure, for example, physical quantities or may detect an operation state of the electronic device 201 and convert measured or detected information into an electrical signal. The sensor module 240 may include, for example, at least one of a gesture sensor 240A, a gyro sensor 240B, a barometric pressure sensor240C, a magnetic sensor 240D, an accelerometer 240E, a grip sensor 240F, a proximity sensor 240G, a color sensor 240H (for example, a red, green, and blue (RGB) sensor), a biometric sensor 2401, a temperature/humidity sensor 240J, an illumination sensor 240K, and an ultraviolet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit to control at least one or more sensors belonging thereto. In an example embodiment, the electronic device 201 may further include a processor configured, as a part of the processors 210 or separately from the processors 210, to control the sensor module 240, thereby controlling the sensor module 240 while the processors 210 are in a sleep state.

The input device 250 may include various input circuitry, such as, for example, and without limitation, a touch panel 252, a (digital) pen sensor 254, a key 256, or an ultrasonic input device 258. The touch panel 252 may use, for example, at least one of an electrostatic type, a pressure-sensitive type, an infrared type, and an ultrasonic type. Further, the touch panel 252 may further include a control circuit. The touch panel 252 may further include a tactile layer to provide a user with a tactile response.

The (digital) pen sensor 254 may, for example, be part of the touch panel or include a separate recognition sheet. The key 256 may include, for example, a physical button, an optical key, or a keypad. The ultrasonic input device 258 may detect ultrasonic waves generated in an input tool through a microphone (for example, a microphone 288) and may identify data corresponding to the detected ultrasonic waves.

The display 260 (for example, a display 160) may include a panel 262, a hologram device 264, or a projector 266. The panel 262 may include a configuration that is the same as, or similar to, that of the display 160 of FIG. 1. The panel 262 may be configured, for example, to be flexible, transparent, or wearable. The panel 262 may be formed with the touch panel 252 in a single module. The hologram device 264 may display a three-dimensional image in the air using the interference of light. The projector 266 may project light onto a screen to display an image. The screen may be disposed, for example, inside or outside the electronic device 201. According to an example embodiment, the display 260 may further include a control circuit to control the panel 262, the hologram device 264, or the projector 266.

The interface 270 may include various interface circuitry, such as, for example, and without limitation, a high-definition multimedia interface (HDMI) 272, a universal serial bus (USB) 274, an optical interface 276, or a D-subminiature (D-sub) 278. The interface 270 may be included, for example, in the communication module 170 illustrated in FIG. 1. Additionally or alternatively, the interface 270 may include, for example, a mobile high-definition link (MHL) interface, an SD card/MMC interface, or an Infrared Data Association (IrDA) interface.

The audio module 280 may convert, for example, a sound and an electrical signal reciprocally. At least some components of the audio module 280 may be included, for example, in an input/output interface 150 illustrated in FIG. 1. The audio module 280 may process sound information input or output, for example, through a speaker 282, a receiver 284, earphones 286, or the microphone 288.

The camera module 291 is a device that takes, for example, a still image and a video. According to an example embodiment, the camera module 291 may include one or more image sensors (for example, a front sensor or a rear sensor), a lens, an image signal processor (ISP), or a flash (for example, an LED, a xenon lamp, or the like).

The power management module 295 may manage, for example, the power of the electronic device 201. According to an example embodiment, the power management module 295 may include a power management integrated circuit, a charger integrated circuit (IC), or a battery or fuel gauge. The power management integrated circuit may have wire-based and/or wireless charging methods. The wireless charging methods may include, for example, a magnetic resonance method, a magnetic induction method, or an electromagnetic wave method, and may further include an additional circuit for wireless charging, such as a coil loop, a resonance circuit, or a rectifier. The battery gauge may measure, for example, the remaining battery charge, the charging voltage, the current, or temperature of the battery 296. The battery 296 may include, for example, a rechargeable battery and/or a solar battery.

The indicator 297 may display a specific state of the electronic device 201 or a component thereof (for example, the processors 210), which may be, for example, a booting state, a message state, or a charging state. The motor 298 may convert an electrical signal into mechanical vibrations and may generate vibrations or a haptic effect. Although not shown, the electronic device 201 may include a processing device for supporting a mobile TV (for example, a GPU). The processing device for supporting the mobile TV may process media data in accordance with digital multimedia broadcasting (DMB), digital video broadcasting (DVB), or mediaFlo™ standards.

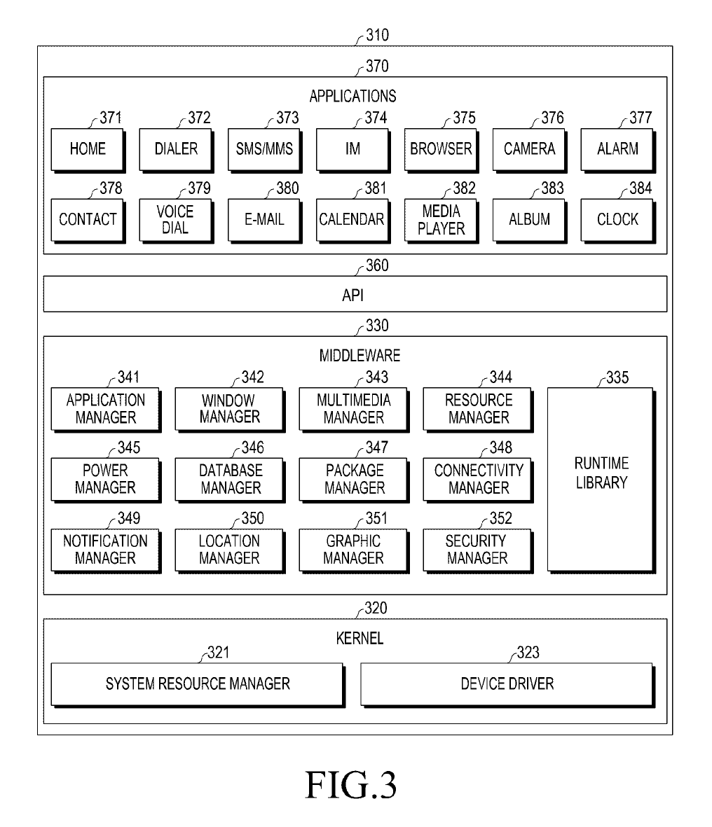

FIG. 3 is a block diagram illustrating an example program module according to various example embodiments. According to an example embodiment, the program module 310 (for example, the program 140) may include an OS that controls resources related to an electronic device (for example, the electronic device 101) and/or various applications (for example, the application program 147) that run on the OS. The OS may be, for example, Android, iOS, Windows, Symbian, Tizen, Bada, or the like.

The program module 310 may include a kernel 320, middleware 330, an API 360, and/or an application 370. At least part of the program module 310 may be preloaded onto the electronic device or may be downloaded from an external electronic device (for example, the electronic device 102 or 104, the server 106, or the like).

The kernel 320 (for example, the kernel 141) may include, for example, a system resource manager 321 and/or a device driver 323. The system resource manager 321 may perform control, allocation, or recovery of system resources; according to an example embodiment, the system resource manager 321 may include a process manager, a memory manager, or a file system manager. The device driver 323 may include, for example, a display driver, a camera driver, a Bluetooth driver, a shared memory driver, a USB driver, a keypad driver, a Wi-Fi driver, an audio driver, or an inter-process communication (IPC) driver.

The middleware 330 may provide, for example, a function commonly needed for applications 370 or may provide the application 370 with various functions through the API 360 so that the application 370 may efficiently use limited systems resources in the electronic device. According to an example embodiment, the middleware 330 (for example, the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 355 may include, for example, a library module used by a complier to add a new function through a programming language while the application 370 is running. The runtime library 355 may perform functions for input/output management, memory management, or arithmetic function.

The application manager 341 may manage, for example, the life cycle of at least one application among the applications 370. The window manager 342 may manage graphic user interface (GUI) resources used for a screen. The multimedia manager 343 may identify formats that are necessary to play various media files and may encode or decode a media file using a codec suitable for a corresponding format. The resource manager 344 may manage resources, such as a source code, a memory, or a storage space, for at least one application among the applications 370.

The power manager 345 may operate with, for example, a basic input/output system (BIOS) to manage a battery or power supply and may provide information on power necessary for an operation of the electronic device. The database manager 346 may generate, retrieve, or change a database to be used for at least one application among the applications 370. The package manager 347 may install or update an application distributed in the form of a package file.

The connectivity manager 348 may manage wireless connectivity, for example, via Wi-Fi or Bluetooth. The notification manager 349 may display or report an incoming message, an appointment, and an event including a proximity notification in a manner that does not disturb a user. The location manager 350 may manage location information on the electronic device. The graphic manager 351 may manage a graphic effect to be provided for the user or a user interface related to the graphic effect. The security manager 352 may provide overall security functions necessary for system security or user authentication. According to an example embodiment, at least some functions of the execution manager 353 may be included in the API 360 or the application 370. According to an example embodiment, when the electronic device (for example, the electronic device 101) has phone features, the middleware 330 may further include a telephony manager to manage a voice or video call function of the electronic device.

The middleware 330 may include a middleware module that forms combinations of various functions of the foregoing components. The middleware 330 may provide a specialized module for each type of an OS in order to provide a differentiated function. Further, the middleware 330 may dynamically delete some of the existing components or add new components.

The API 360 (for example, the API 145) is, for example, a set of API programming functions and may be provided with a different configuration depending on an OS. For example, one API set for each platform may be provided in Android or iOS, while two or more API sets for each platform may be provided in Tizen.

The application 370 (for example, the application program 147) may include one or more applications that are capable of performing functions of, for example, a home 371, a dialer 372, an SMS/MMS 373, an instant message (IM) 374, a browser 375, a camera 376, an alarm 377, a contact 378, a voice dial 379, an email 380, a calendar 381, a media player 382, an album 383, a clock 384, or a health care (for example, for measuring exercising or blood sugar), an environmental data application (for example, for providing atmospheric pressure, humidity, or temperature data), or the like.

According to an example embodiment, the application 370 may include an application (hereinafter, “information exchange application” for convenience of description) that supports information exchanges between the electronic device (for example, the electronic device 101) and an external electronic device (for example, the electronic device 102 or 104). The information exchange application may include, for example, a notification relay application for relaying specific information to the external electronic device or a device management application for managing the external electronic device.

For example, the notification relay application may include a function of relaying notification information, which is generated in another application (for example, the SMS/MMS application, the email application, the health care application, the environmental data application, or the like) of the electronic device, to the external electronic device (for example, the electronic device 102 or 104). Additionally, the notification relay application may receive notification information, for example, from the external electronic device and provides the notification information to the user.

The device management application may manage (for example, install, delete, or update), for example, at least one function (for example, a function of turning on/turning off the external electronic device itself (or some components) or adjusting the brightness (or resolution) of a display) of the external electronic device (for example, the electronic device 102 or 104) communicating with the electronic device, an application operating in the external electronic device, or a service (for example, a call service or message service) provided by the external electronic device.

According to an example embodiment, the application 370 may include an application (for example, a health care application of a mobile medical device) assigned according to an attribute of the external electronic device (for example, the electronic device 102 or 104). According to an example embodiment, the application 370 may include an application received from the external electronic device (for example, the server 106 or the electronic device 102 or 104). According to an example embodiment, the application 370 may include a third party application that may be downloaded from a preloaded application or the server. The illustrated components of the program module 310, according to the example embodiments, may be named different terms depending on an OS type.

According to various example embodiments, at least part of the program module 310 may be implemented in software, firmware, hardware (e.g., circuitry), or combinations of at least two or more. At least part of the program module 310 may be implemented (for example, run) by, for example, a processor (for example, the processor 210). At least part of the program module 310 may include, for example, a module, a program, a routine, sets of instructions, or a process to perform one or more functions.

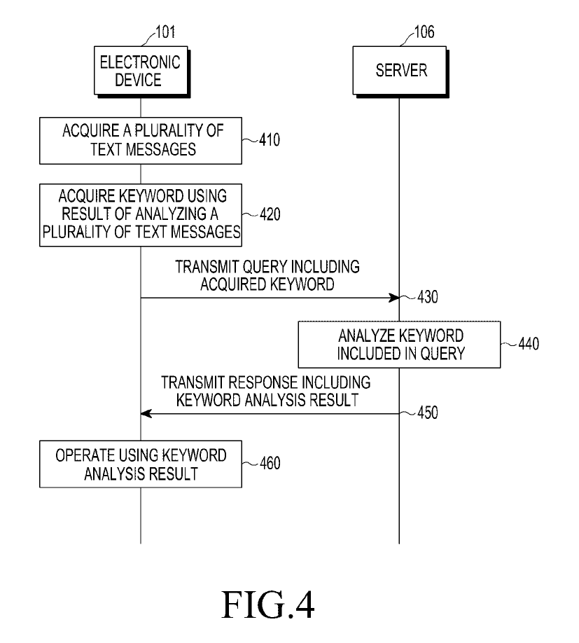

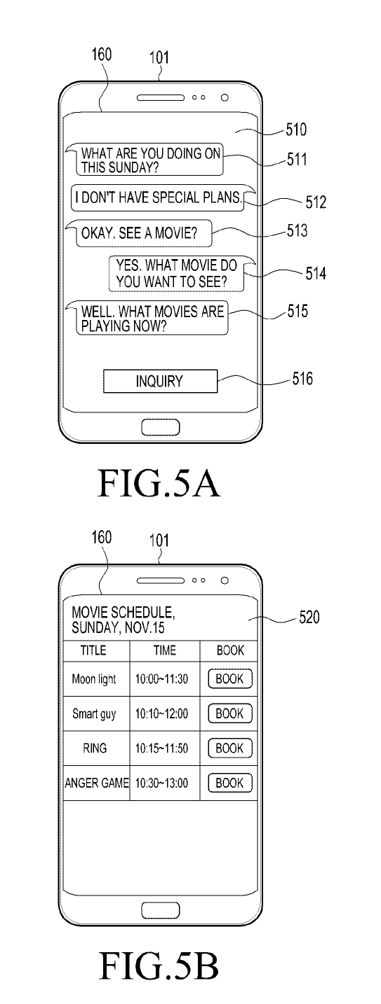

FIG. 4 is a flowchart illustrating an example method of operating an electronic device according to various example embodiments of the present disclosure. The embodiment of FIG. 4 is described in greater detail with reference to FIG. 5A and FIG. 5B. FIG. 5A and FIG. 5B are diagrams illustrating an example electronic device according to various example embodiments of the present disclosure.

In operation 410, the electronic device 101 may acquire a plurality of text messages. For example, a text message may refer, for example, to a text including at least one of letters, numbers, and symbols. In an example embodiment, a text message may be separated by a data format. For example, user A and user B may exchange text messages with each other using a chat application. User A may input a text to send in a chat window, and may input a preset send command after completely inputting a text in the chat window. The chat application may transmit a text message including the input text to another electronic device according to the send command and may display a text message received from the other electronic device. In another example embodiment, a text message may be separated by a natural language processing result. For example, the electronic device 101 may identify an ending word of a sentence based on a text analysis result and may separate a text message using the ending word of the sentence. In this example, a text group defined as one sentence may be separated as one text message. In still another example embodiment, a text message may be separated by time. For example, the electronic device 101 may separate, as one text message, a group of texts that are successively input without a pause. In this example, when texts are successively input to exceed a preset pause, the electronic device 101 may acquire groups of texts that are input before the pause as one text message. Accordingly, the text message may include one or more sentences. As described above, a text message may be separated by various criteria.

According to various example embodiments of the present disclosure, the electronic device 101 may acquire a plurality of texts input or received from another electronic device. The electronic device 101 may also acquire a plurality of texts processed in an application, for example, a chat application. The electronic device 101 may perform text-to-speech (TTS) processing on a plurality of user voices, which is acquired from the outside through a microphones, thereby acquiring a plurality of texts.

For example, as illustrated in FIG. 5A, the electronic device 101 may display a chat application execution screen 510 on the display 160. The electronic device 101 may run the chat application and, accordingly, may display the chat application execution screen 510. The electronic device 101 may display text messages 511, 513, and 515 received from another electronic device (not shown) and may display text messages 512 and 514 input by a user. It would be easily understood by a person skilled in the art that the chat application may be any application that enables the transmission and reception of text messages between both electronic devices. The electronic device 101 may display a graphic user interface to distinguish histories of text messages transmitted and received by chat participants as in FIG. 5A. As illustrated in FIG. 5A, the electronic device 101 may acquire a plurality of text messages including the text messages from the user and the text messages received from the other electronic device.

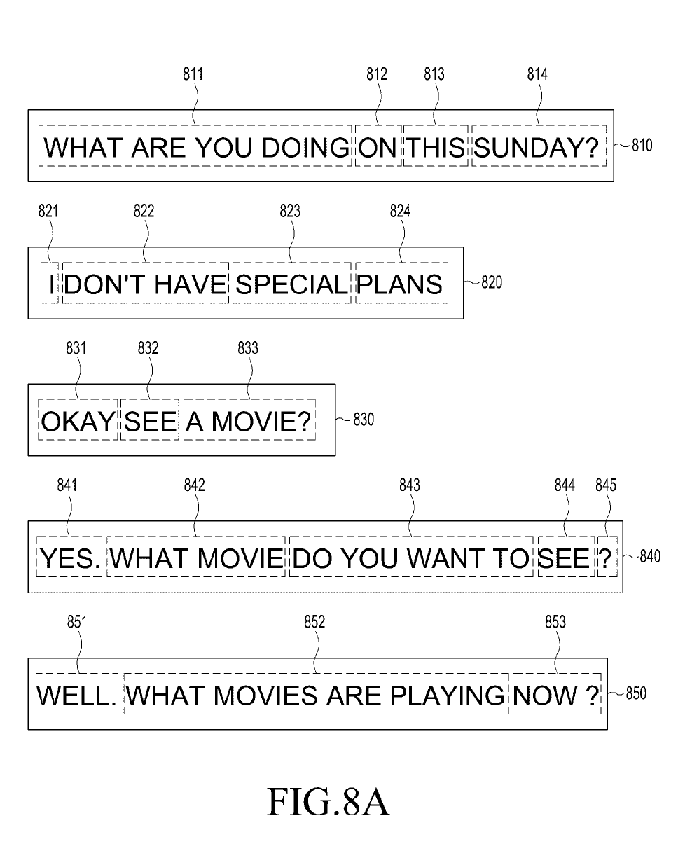

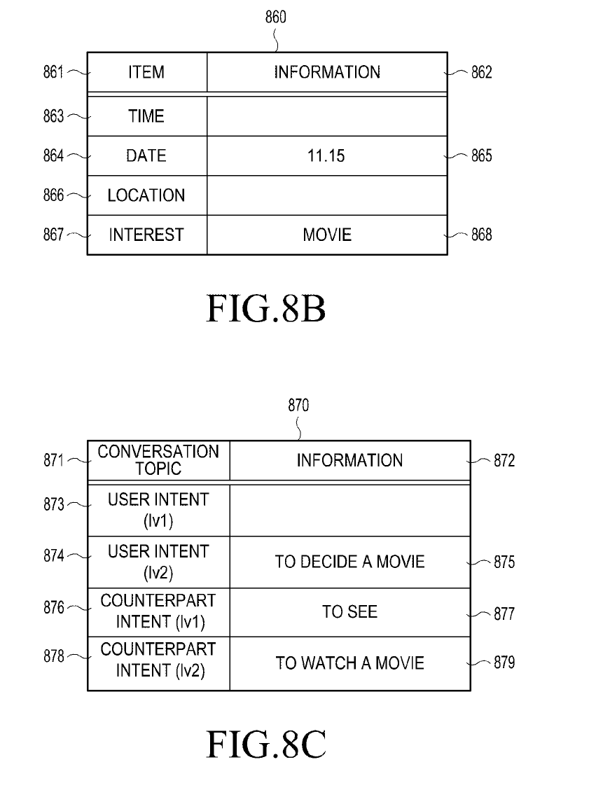

In operation 420, the electronic device 101 may acquire a keyword using an analysis result of the plurality of text messages. The electronic device 101 may analyze each of the text messages and may acquire a keyword using an analysis of each text message. In various example embodiments of the present disclosure, the electronic device 101 may match an analysis result of each of the plurality of text messages with a template, thereby generating a keyword. The electronic device 101 may apply a machine learning or deep learning algorithm that analyzes user intent from an analysis result of each of the plurality of text messages, thereby generating a keyword. A keyword generation process according to various example embodiments will be described in greater detail below with reference to FIG. 8A to FIG. 8C. In the example embodiment of FIG. 5A, the electronic device 101 may generate a keyword of “movie, this Sunday.” For example, the electronic device 101 may acquire a text corresponding to time of “this Sunday” based on a natural language analysis result of a text message 511 of “What are you doing on this Sunday.” For example, the electronic device 101 may identify, based on the natural language analysis result, that “this Sunday” of the text message 511 is the text corresponding to time and that “What are you doing?” is a text corresponding to a verb. Natural language analysis may be used to determine the role of each component of a text message in a sentence, and the electronic device 101 may analyze each component of the plurality of text messages based on a natural language analysis result.

In addition, the electronic device 101 may acquire a text corresponding to an object of “movie” based on a natural language analysis result of a text message 513 of “Okay. See a movie?” The electronic device 101 may acquire a keyword of “movie, this Sunday” using an analysis result of the text messages 511 and 513. The electronic device 101 may previously store an algorithm for classifying a text corresponding to time and a text corresponding to an object as a keyword and may acquire a keyword based on a result of applying the algorithm. The electronic device 101 may acquire an object, for example, “plans” or “what you want to see,” from other text messages 512, 514, and 515, and may include the object in the keyword or may exclude the object via filtering. The electronic device 101 may previously store a database of objects having slightly ambiguous meanings and may exclude these objects from the keyword generation process. The electronic device 101 may generate a keyword based on user intent acquired by analyzing the text messages 511 to 515 using the machine learning or deep learning algorithm. The electronic device 101 may analyze the text message 512 to determine user intent as “plans” and may analyze the text messages 511 and 513 to determine user intent as “to see a movie this Sunday.” The electronic device 101 may analyze the text message 511 to analyze the intent of the user asking about a counterpart's schedule this Sunday and may analyze, through the machine learning or deep learning algorithm, that the text message 513 for additional asking after the above asking indicates an activity to perform at the time. As described above, the electronic device 101 may use various methods to analyze a keyword, and a person skilled in the art would easily understand that any kind of method may be used without restriction as long as it can analyze a keyword using a plurality of text messages.

In operation 430, the electronic device 101 may transmit a query including the acquired keyword. For example, as illustrated in FIG. 5A, the electronic device 101 may display a graphic user interface 516 to request a keyword analysis result and may transmit the query including the keyword to the server 106 corresponding to a designation of the graphic user interface 516.

In operation 440, the server 106 may analyze the keyword included in the query. The server 106 may refer, for example, to any electronic device that stores an algorithm or program capable of analyzing a keyword. In various example embodiments of the present disclosure, the server 106 may also forward the keyword to another electronic device, which will be described in greater detail below. For example, the server 106 may analyze the keyword of “movie, this Sunday” acquired from the electronic device 101 to acquire a movie schedule for this Sunday.

In operation 450, the server 106 may transmit a response including a keyword analysis result to the electronic device 101. In operation 460, the electronic device 101 may operate using the keyword analysis result. For example, as illustrated in FIG. 5B, the electronic device 101 may display a graphic user interface 520 including the keyword analysis result of the movie schedule for this Sunday received from the server 106.

For example, since a conventional electronic device provides an analysis result of one text message only, that is, provides an analysis result of “this Sunday” in the text message 511, inaccurate information is provided. In addition, since the conventional electronic device provides an analysis result of “movie” in one text message 513, inaccurate information is provided. On the other hand, the electronic device 101 according to various example embodiments of the present disclosure may operate according to a keyword analysis result based on a plurality of text messages, thereby providing information to further satisfy user intent.

In various example embodiments of the present disclosure, the server 106 may receive the plurality of text messages, instead of the keyword acquired based on an analysis result of the plurality of text messages. The server 106 may analyze the plurality of received text messages to generate a keyword and may transmit an analysis result of the generated keyword to the electronic device 101. A keyword generation process of the server 106 may be the same as the keyword generation process of the electronic device 101.

In various example embodiments of the present disclosure, the electronic device 101 may autonomously analyze a keyword without making a request for a keyword analysis to another electronic device. In another example embodiment, the electronic device 101 may immediately implement a command corresponding to a keyword.

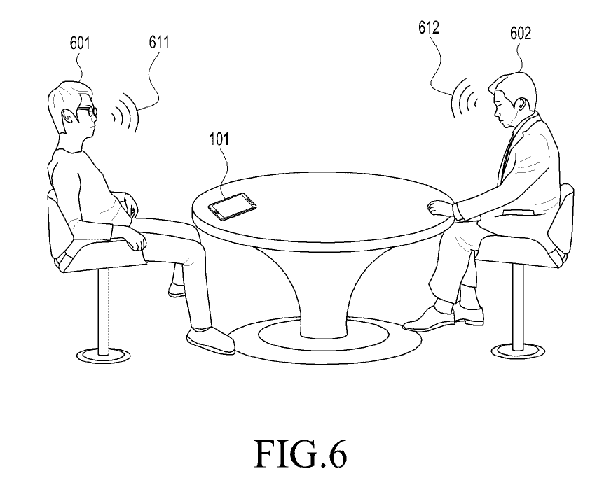

FIG. 6 is a diagram illustrating example acquisition of a text message according to various example embodiments of the present disclosure.

As illustrated in FIG. 6, the electronic device 101 may acquire a plurality of user voices 611 and 612 uttered by a plurality of users 601 and 602. The electronic device 101 may include, for example, a microphone, and may convert the user voices 611 and 612 into electrical signals through the microphone. The electronic device 101 may perform TTS processing on the user voices 611 and 612, thereby acquiring a plurality of text messages corresponding to the user voices 611 and 612. The electronic device 101 may process, as one text message, a result of converting user voices successively acquired without a preset pause. In addition, the electronic device 101 may process a user voice using a voiceprint. For example, even when the two users 601 and 602 utter users voices at the same time, the electronic device 101 may separately process the user voices 611 and 612, which are uttered by the respective users 601 and 602, using voiceprints. For example, as illustrated in FIG. 5A, the users 601 and 602 may utter the user voices 611 and 612 having contents of “What are you doing on this Sunday?”, “I don't have special plans.”, “Okay. See a movie?”, “Yes. What movie do you want to see?”, and “Well. What movies are playing now?” The electronic device 101 may perform TTS processing on the user voices 611 and 612 to acquire text messages as illustrated in FIG. 5A. When a keyword analysis result request is detected, the electronic device 101 may transmit a query including a keyword using an analysis result of the plurality of text messages and may acquire a keyword analysis result as a response to the query. Accordingly, the electronic device 101 of FIG. 6 may display the graphic user interface 520 including the keyword analysis result as illustrated in FIG. 5B.

As described above, the electronic device 101 according to various example embodiments of the present disclosure may acquire a plurality of text messages in various manners.

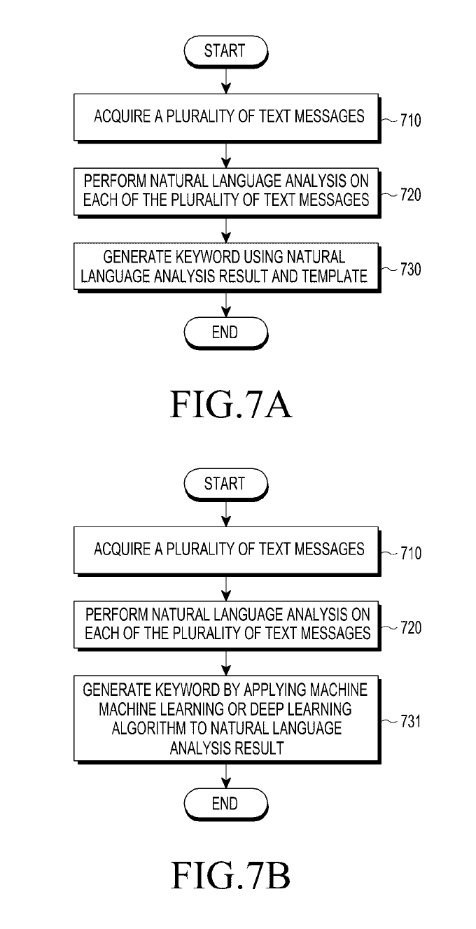

FIG. 7A and FIG. 7B are flowcharts illustrating an example method of operating an electronic device according to various example embodiments of the present disclosure.

Referring to FIG. 7A, in operation 710, the electronic device 101 may acquire a plurality of text messages. As described above, the electronic device 101 may acquire a text message including a text or may acquire a text by performing TTS processing on a user voice.

In operation 720, the electronic device 101 may perform the natural language analysis of each of the plurality of text messages. FIG. 8A is a diagram illustrating example natural language analysis by an electronic device according to various example embodiments of the present disclosure. The electronic device 101 may acquire a plurality of text messages 810, 820, 830, 840, and 850. The electronic device 101 may perform the natural language analysis of a text message 810, thereby determining that “this” 813 in the text message 810 is a text corresponding to time, “Sunday” 814 is a text corresponding to time, “on” 812 is a text corresponding to a postposition, and “what are you doing” 811 is a text corresponding to a verb. The electronic device 101 may also perform the natural language analysis of other text messages 820, 830, 840, and 850 to determine the attributes of included components 821, 822, 823, 824, 831, 832, 833, 841, 842, 843, 844, 845, 851, 852, and 853.

In operation 730, the electronic device 101 may generate a keyword using, for example, a natural language analysis result and a template. In various example embodiments of the present disclosure, the electronic device 101 may store a template 860 illustrated in FIG. 8B. The template 860 may include at least one item 861, and information 862 may be mapped by at least one item 861. For example, the electronic device 101 may store the template 860 including a time item 863, a date item 864, a location item 866, and an interest item 867. The electronic device 101 may store, as the information 862, a component corresponding to an item of the template 860 among natural language analysis results, thereby generating a keyword. For example, the electronic device 101 may map the time item 863 or date item 864 to components 813 and 814 corresponding to time and may store the components 813 and 814 as information 865. The electronic device 101 may map the interest item 867 to the component 833 corresponding to an object and may store the component 833 as information 868. The electronic device 101 may generate a keyword using the information 862 mapped to the item 861 of the template. For example, in the example embodiment of FIG. 8B, the electronic device 101 may generate a keyword of “11.15, movie.” For example, the electronic device 101 may replace a text of “this Sunday” with a text of 11.15 and may store the text of 11.15.

As described above, the electronic device 101 according to various example embodiments of the present disclosure may generate a keyword based on a comparison with the template 860.

FIG. 7B is a flowchart illustrating an example learning-based keyword generation process according to various example embodiments of the present disclosure. Operation 710 and operation 720 are described above, and thus repeated descriptions thereof are omitted herein. In operation 731, the electronic device 101 may generate a keyword by applying a machine learning or deep learning algorithm to a natural language analysis result. For example, as illustrated in FIG. 8C, the electronic device 101 may apply the machine learning or deep learning algorithm to a pattern by user intent analyzed in advance and may also apply the machine learning or deep learning algorithm to the plurality of acquired text messages. Accordingly, the electronic device 101 may map information 872 by conversation topic 871 in the template 870. The electronic device 101 may determine user intent by abstraction levels 873, 874, 876 and 878 to store the user intent or counterpart intent as information. For example, it is assumed that a higher abstraction level denotes clearer user intent. For example, the electronic device 101 may determine through the analysis of a text message 840 that user intent is to decide a movie 875. For example, the electronic device 101 may determine user intent by text messages 810, 820, 830, 840, and 850. The electronic device 101 may generate a keyword using user intent more specifically determined among user intents determined by text messages. For example, the electronic device 101 may determine that “to see” 877 is specific counterpart intent in the text message 810 and may determine that “to watch a movie” 879 is specific counterpart intent in the text message 830. The electronic device 101 may determine a text corresponding to more specific user intent through machine learning or deep learning. The electronic device 101 may generate a keyword of “this Sunday, to watch a movie” using a result of applying machine learning or deep learning to a plurality of texts.

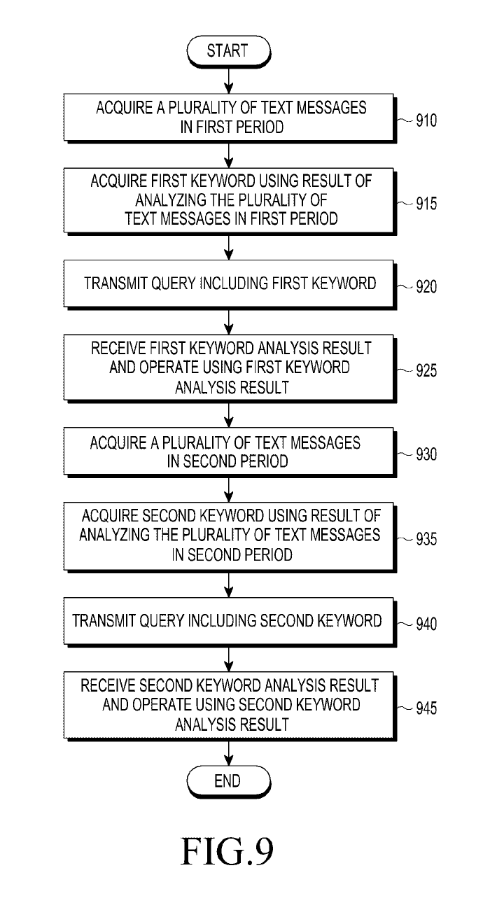

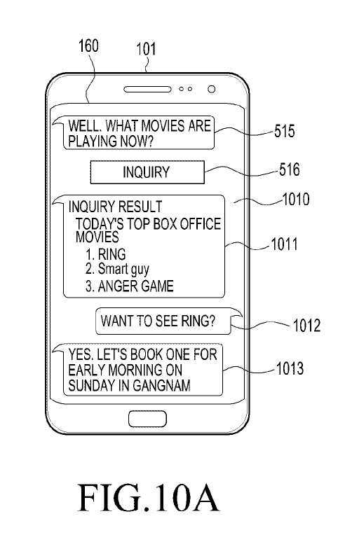

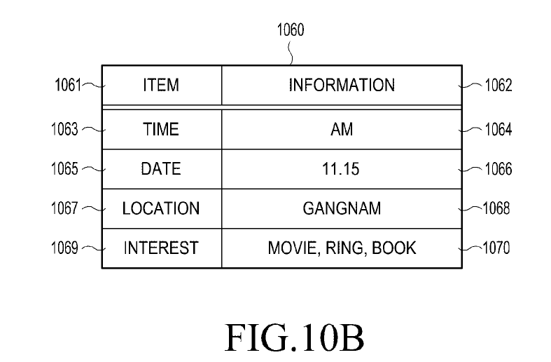

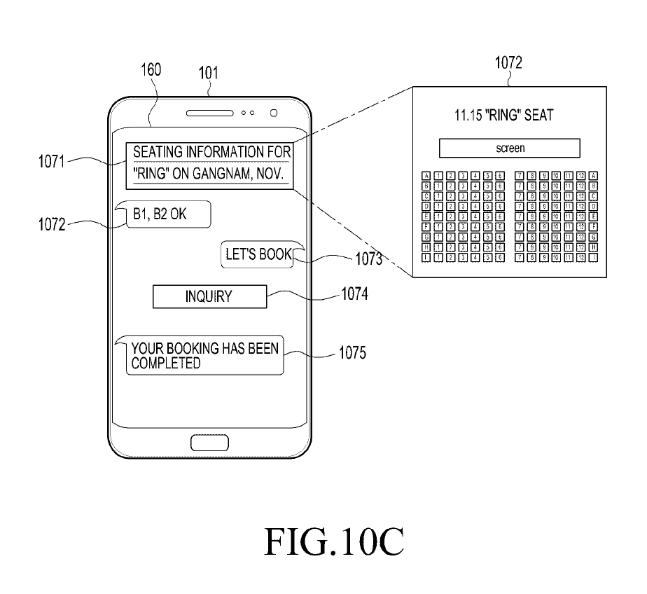

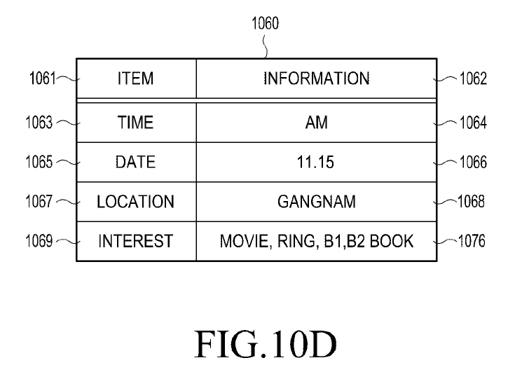

FIG. 9 is a flowchart illustrating an example method of operating an electronic device according to various example embodiments of the present disclosure. The embodiment of the FIG. 9 is described in greater detail with reference to FIG. 10A to FIG. 10D.

In operation 910, the electronic device 101 may acquire a plurality of text messages in a first period. In operation 915, the electronic device 101 may acquire a first keyword using an analysis result of the plurality of text messages in the first period. In operation 920, the electronic device 101 may transmit a query including the first keyword. In operation 925, the electronic device 101 may receive an analysis result of the first keyword and may operate using the analysis result of the first keyword. FIG. 10A is a diagram illustrating the electronic device 101 according to various example embodiments of the present disclosure, in which it is assumed, for example, that the electronic device 101 displays a graphic user interface after FIG. 5A. The electronic device 101 may display a graphic user interface 1011 including a today's box office chart as the analysis result of the first keyword of “this Sunday, movie.” For example, the electronic device 101 may transmit a query including the first keyword of “this Sunday, movie” and may receive and display information on the today's box office chart as a response to the query.

In operation 930, the electronic device 101 may acquire a plurality of text messages in a second period. For example, the first period and the second period may be divided on the basis of an operation based on a keyword analysis request or keyword analysis result. For example, as illustrated in FIG. 10A, after displaying the graphic user interface 1011 corresponding to the keyword analysis result, the electronic device 101 may acquire a plurality of text messages 1012 and 1013. The electronic device 101 may display the plurality of text messages 1012 and 1013 on a chat application execution screen 1010.

In operation 935, the electronic device 101 may acquire a second keyword using an analysis result of the plurality of text messages in the second period. For example, the electronic device 101 may acquire the second keyword based on a template. The electronic device 101 may independently acquire the second keyword from the plurality of text messages in the second period, while the electronic device 101 according to various example embodiments of the present disclosure may acquire the second keyword based on the plurality of text messages in the first period and the plurality of text messages in the second period. The electronic device 101 may acquire the second keyword based on the first keyword and the plurality of text messages in the second period. FIG. 10B is a diagram illustrating the generation of a keyword according to various example embodiments of the present disclosure. The electronic device 101 may generate the second keyword based on information 1062 by item 1061 of a template 1060. For example, the electronic device 101 may acquire information 1066 of Nov. 15 for a date item 1065 and information 1070 of movie for an interest item 1069 based on the text messages in the first period. Meanwhile, the electronic device 101 may acquire information 1064 of A.M. for a time item 1063, information 1068 of Gangnam for a location item 1067, and information 1070 of Ring and booking for the interest item 1069 based on the text messages in the second period. An information acquiring method of the electronic device 101 based on the text messages in the second period may be the same as a method of acquiring information in the first period and has been described above, and thus a repeated description thereof is omitted herein. In the example embodiment of FIG. 10B, the electronic device 101 may generate the second keyword of “Nov. 15, A.M., Gangnam, movie, Ring, booking.” In another example embodiment, the electronic device 101 may generate a keyword of “A.M., Gangnam, Ring, booking” based on the analysis result of the text messages in the second period and may combine the keyword with the first keyword in the first period of “Nov. 15, movie” to generate the second keyword of “Nov. 15, A.M., Gangnam, movie, Ring, booking.”

In operation 940, the electronic device 101 may transmit a query including the second keyword. In operation 945, the electronic device 101 may receive an analysis result of the second keyword and may operate using the analysis result of the second keyword. For example, the electronic device 101 may transmit the query including the second keyword of “Nov. 15, A.M., Gangnam, movie, Ring, booking” and may receive an analysis result thereof. The electronic device 101 may display a graphic user interface 1071 including the received analysis result, for example, as in FIG. 10C. For example, the graphic user interface 1071 may include a hyperlink to a booking screen 1072 of a movie booking site.

The electronic device 101 may further acquire a plurality of text messages 1072 and 1073 in a third period after the second period and may display the plurality of acquired text messages 1072 and 1073. The electronic device 101 may analyze the text messages 1072 and 1073 in the third period to generate a third keyword. For example, the electronic device 101 may generate a keyword illustrated in FIG. 10D using an analysis result of the text messages in the third period. Referring to FIG. 10D, the electronic device 101 may generate the third keyword of “Nov. 15, A.M., Gangnam, movie, Ring, B1 and B2 booked” 1076 for the interest item 1069 using the text messages 1072 and 1073 in the third period and the text messages in the first and second periods. When a designation of a graphic user interface 1074 corresponding to a request for the analysis of the third keyword is detected, the electronic device 101 may transmit a query including the third keyword. A server (not shown) may process the third keyword to book B1 and B2 for the movie Ring at a Gangnam branch in the morning on Nov. 15 and may transmit a booking result as a response to the electronic device 101. The electronic device 101 may display the received response, that is, a message 1075 indicating that the booking has been completed.

As described above, the electronic device 101 according to various example embodiments of the present disclosure may analyze a plurality of text messages respectively acquired in a plurality of periods, not in one period, thereby generating a plurality of keywords corresponding to the respective periods. When the electronic device 101 generates a keyword corresponding to one period, the electronic device 101 may refer to a text message or keyword corresponding to a period that is different from the one period.

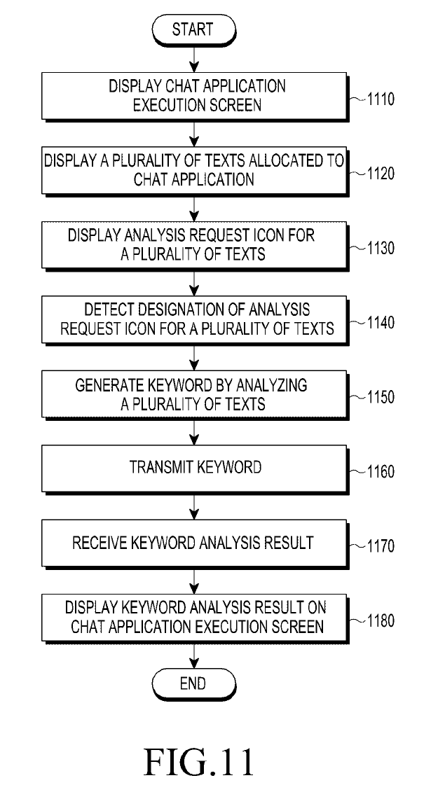

FIG. 11 is a flowchart illustrating an example method of operating an electronic device according to various example embodiments of the present disclosure.

In operation 1110, the electronic device 101 may display a chat application execution screen. In operation 1120, the electronic device 101 may display a plurality of texts allocated to a chat application. For example, the chat application execution screen may be configured such that a text message input to the electronic device 101 and a text message received from another electronic device are displayed on one screen. The chat application is configured to dispose the text message input to the electronic device 101 at one side and to dispose the text message received from the other electronic device at another side, thus allowing a user to easily distinguish the text message input by the user and the text message input by a counterpart.

In operation 1130, the electronic device 101 may display an analysis request icon for the plurality of texts. In operation 1140, the electronic device 101 may detect a designation of the analysis request icon for the plurality of texts. The electronic device 101 may display the analysis request icon for the texts, and may request the analysis of the texts when the icon is designated. In another example embodiment, when a text requesting the analysis of the texts is input, the electronic device 101 may display the input text and may request the analysis of the texts.

In operation 1150, the electronic device 101 may generate a keyword by analyzing the plurality of texts. In operation 1160, the electronic device 101 may transmit the keyword. In operation 1170, the electronic device 101 may receive an analysis result of the keyword. In operation 1180, the electronic device 101 may display the analysis result of the keyword on the chat application execution screen.

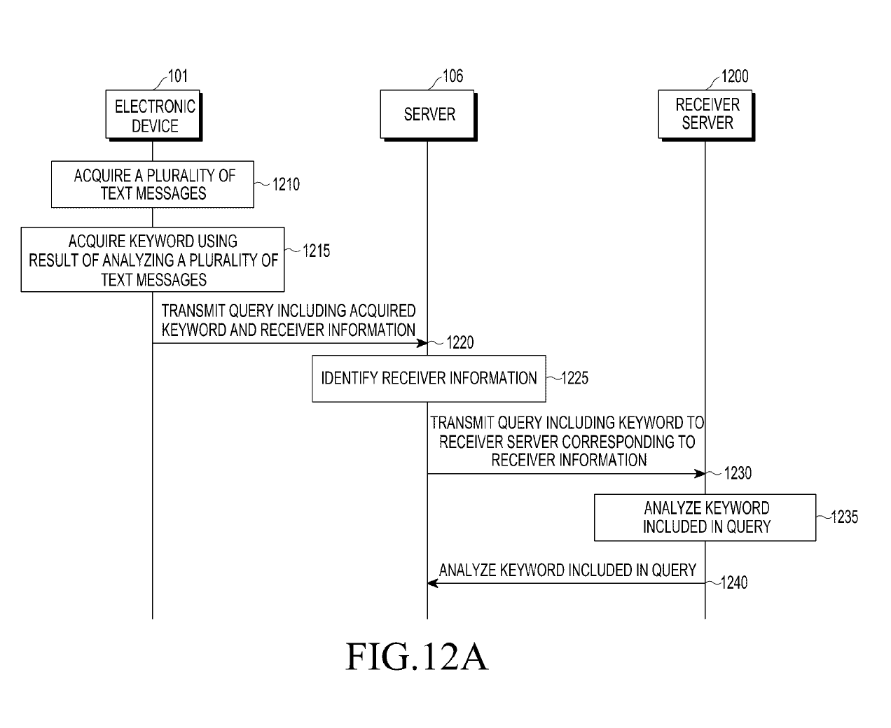

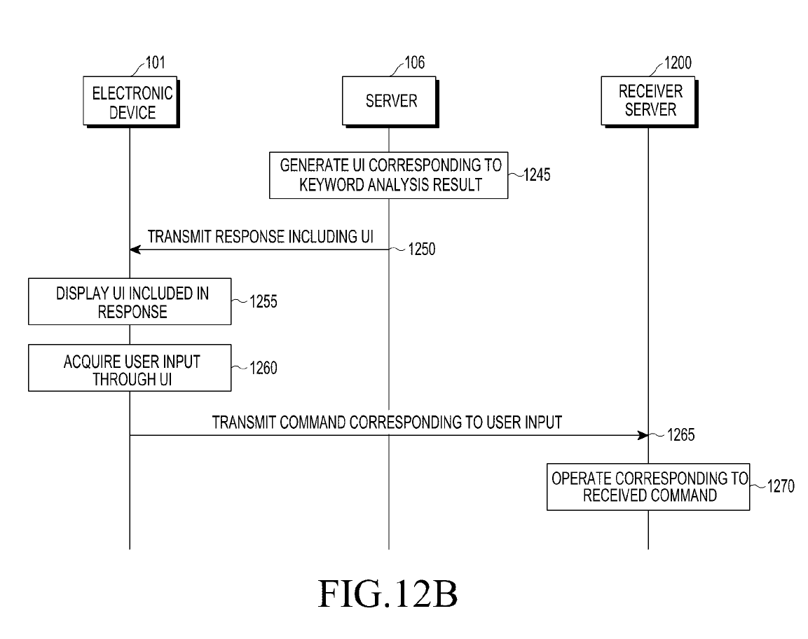

FIG. 12A and FIG. 12B are flowcharts illustrating an example method of operating an electronic device according to various example embodiments of the present disclosure.

In operation 1210, the electronic device 101 may acquire a plurality of text messages. In operation 1215, the electronic device 101 may acquire a keyword using an analysis result of the plurality of text messages. Since operation 1210 and operation 1215 have been previously described in detail, repeated descriptions thereof are omitted herein.

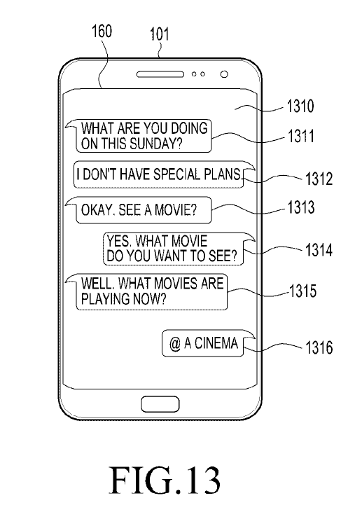

In operation 1220, the electronic device 101 may transmit a query including the acquired keyword and receiver information. FIG. 13 is a diagram of the electronic device according to various example embodiments of the present disclosure. As illustrated in FIG. 13, the electronic device 101 may receive information on a receiver to analyze a plurality of text messages 1311 to 1315 and may display input information 1316. For example, the user may want “A cinema” to perform the analysis of the plurality of text messages 1311 to 1315 and accordingly may input a text message including the receiver information as the information 1316. The electronic device 101 may display the input information 1316 on a chat application screen 1310 for user's confirmation.

In operation 1225, the server 106 may identify the receiver information. In operation 1230, the server 106 may transmit the query including the keyword to a receiver server 1200 corresponding to the receiver information. The server 106 according to various example embodiments of the present disclosure may store a database of receiver information in advance and may forward the query including the keyword using the database. The server 106 may store a database in which receiver information in a semantic form from the electronic device 101 is mapped to an identifier of the receiver and, accordingly, may map various forms of receiver information to a specific receiver server. For example, when receiver information input by the user is received even in diverse input forms, for example, “A,” “A theater,” and the like, instead of “A cinema,” the server 106 may determine the receiver information as “A cinema” and may forward the query to a receiver server 1200 of “A cinema.”

In operation 1235, the receiver server 1200 may analyze the keyword included in the query. In operation 1240, the receiver server 1200 may transmit a response including an analysis result of the keyword to the server 106. In various example embodiments of the present disclosure, the server 106 may also transmit identification information on the electronic device 101, along with the query, to the receiver server 1200, in which case the receiver server 1200 may transmit the analysis result of the keyword directly to the electronic device 101, not via the server 106.

In operation 1245, the server 106 may generate a user interface (UI) corresponding to the analysis result of the keyword. In operation 1250, the server 106 may transmit a response including the UI to the electronic device 101. In various example embodiments of the present disclosure, the server 106 may also transmit the analysis result of the keyword directly to the electronic device 101.

In operation 1255, the electronic device 101 may display the UI included in the response. In operation 1260, the electronic device 101 may acquire a user input through the UI. In operation 1265, the electronic device 101 may transmit a command corresponding to the user input to the receiver server 1200 directly or via the server 106. In operation 1270, the receiver server 1200 may operate corresponding to the received command.

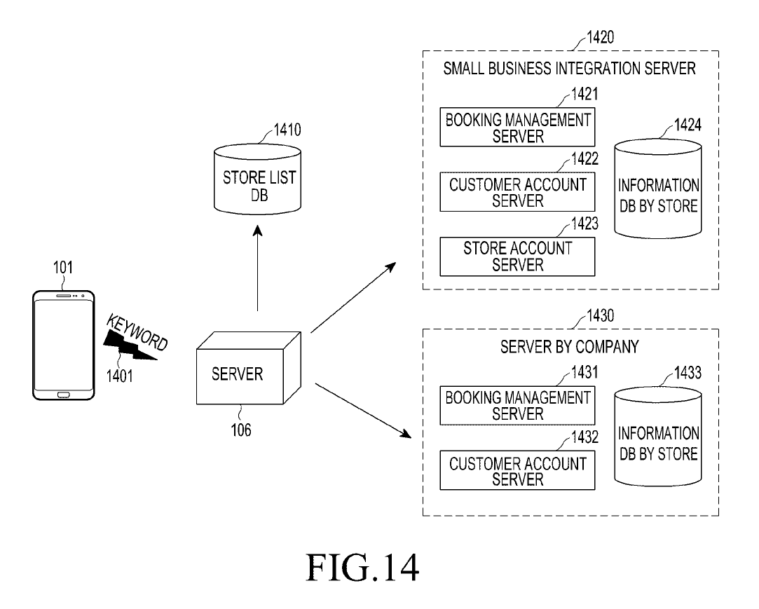

FIG. 14 is a diagram illustrating an example receiver server according to various example embodiments of the present disclosure.

In an example embodiment, the electronic device 101 may transmit receiver information and a keyword 1401 to the server 106. The server 106 may store a store list database 1410 as an example of a receiver information database. The store list database 1410 may store receiver information, for example, a text corresponding to a receiver, mapped to an identifier of a store. For example, the server 106 may store a store list database illustrated, for example, in Table 1.

TABLE 1

| Text | Identifier |
|---|---|
| A, A cinema, A movie, A theater | A cinema |
| B, B hospital, B dermatology clinic, B skin | B dermatology clinic |
| C, C shoes, D clothing store, D T-shirt, E | F small business |
| sunglasses | association |

As listed in Table 1, the server 106 may store a semantic text mapped to an identifier. Accordingly, when receiver information relating to, for example, “A movie” is received along with a keyword from the electronic device 101, the server 106 may transmit a query including the keyword to a receiver server of A cinema. Meanwhile, small business owners may have difficulty in managing an individual server, and thus the small business owners may manage a small business integration server in association.

In various example embodiments of the present disclosure, a small business integration server 1420 may include a booking management server 1421, a customer account server 1422, a store account server 1423, and an information database by store 1424, or the like, but is not limited thereto. The booking management server 1421 may perform a booking when the query includes booking information. The customer account server 1422 may manage user accounts. The store account server 1423 may manage the accounts of store managers. The information database by store 1424 may store individual information on a joining store.

In various example embodiments of the present disclosure, a server by company 1430 may be configured as an individual receiver server. The server by company 1430 may include a booking management server 1431, a customer account server 1432, and an information database by store 1433, or the like, but is not limited thereto.

The small business integration server 1420 or the server by company 1430 may analyze or process the keyword included in the query. Further, the small business integration server 1420 or the server by company 1430 may transmit an analysis result or processing result to the electronic device 101.

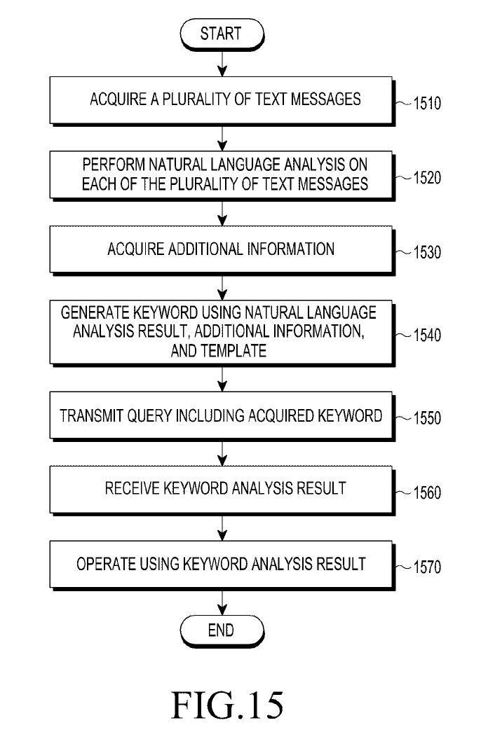

FIG. 15 is a flowchart illustrating an example method of operating an electronic device according to various example embodiments of the present disclosure.

In operation 1510, the electronic device 101 may acquire a plurality of text messages. In operation 1520, the electronic device 101 may perform the natural language analysis of each of the plurality of text messages. In operation 1530, the electronic device 101 may acquire additional information. For example, the additional information may refer to all information that can be acquired through routes other than a route for acquiring the text messages. For example, the electronic device 101 may include information from another application that is different from an application for acquiring the text messages.

In operation 1540, the electronic device 101 may generate a keyword using a natural language analysis result, the additional information, and a template. In operation 1550, the electronic device 101 may transmit a query including the acquired keyword. In operation 1560, the electronic device 101 may receive an analysis result of the keyword. In operation 1570, the electronic device 101 may operate using the analysis result of the keyword.

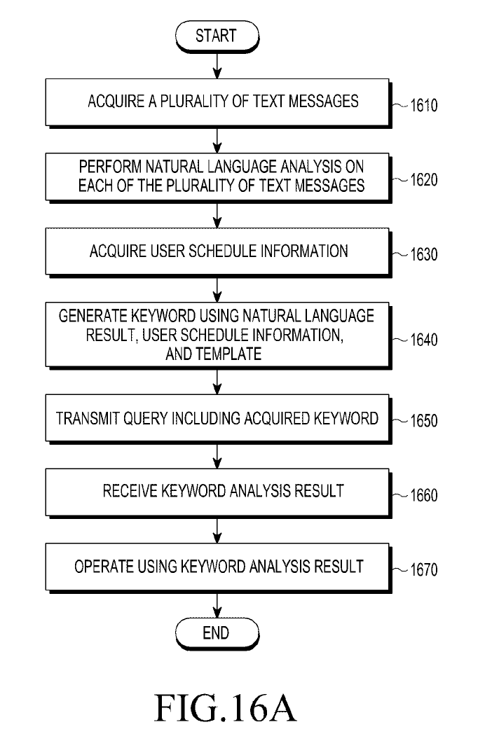

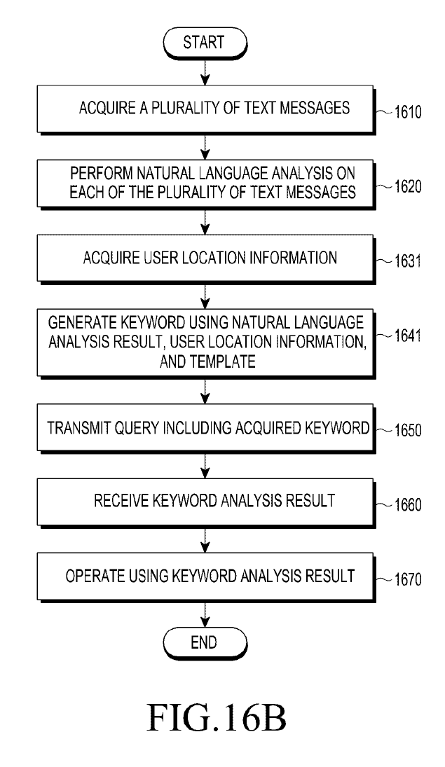

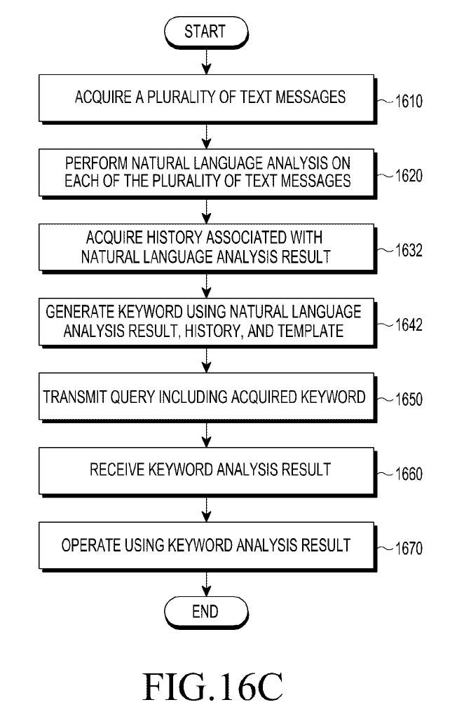

Hereinafter, the generation of a keyword using various pieces of additional information will be described in greater detail with reference to FIG. 16A to FIG. 16C.

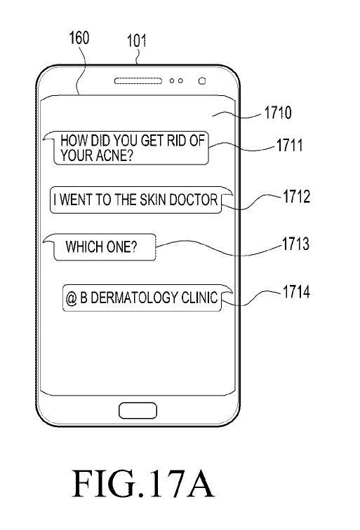

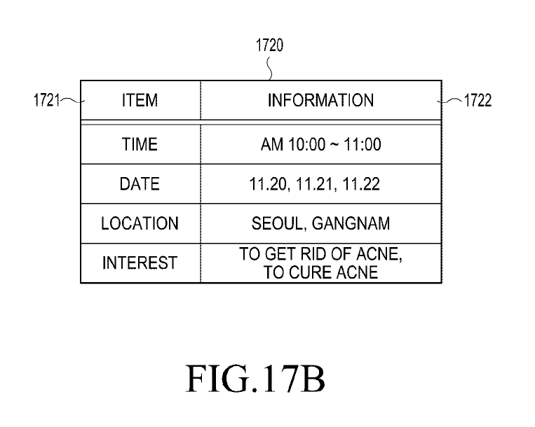

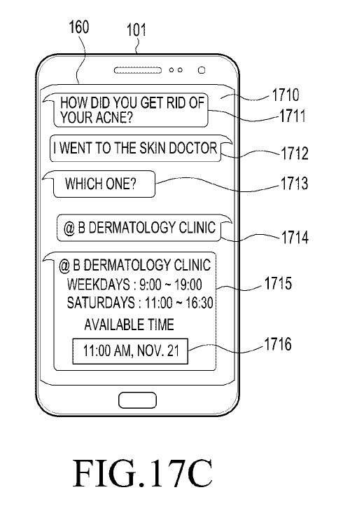

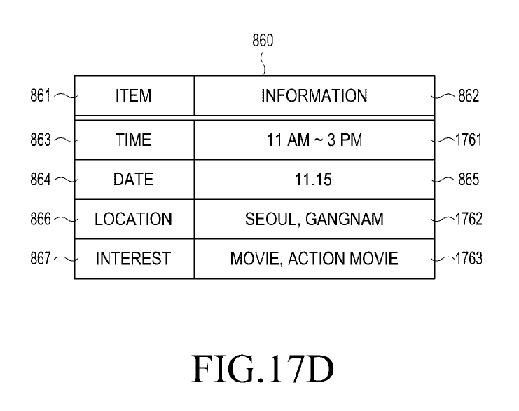

FIG. 16A to FIG. 16C are flowcharts illustrating example generation of a keyword further using additional information according to various example embodiments of the present disclosure. FIG. 16A to FIG. 16C are described in greater detail with reference to FIG. 17A to FIG. 17D. FIG. 17A to FIG. 17D are diagrams illustrating example generation of a keyword further using additional information according to various example embodiments of the present disclosure.

Referring to FIG. 16A, in operation 1610, the electronic device 101 may acquire a plurality of text messages. In operation 1620, the electronic device 101 may perform natural language analysis of each of the plurality of text messages. For example, as illustrated in FIG. 17A, the electronic device 101 may run a chat application to display a chat application execution screen 1710 on the display 160. The electronic device 101 may display the plurality of acquired text messages 1711 to 1714. In various example embodiments of the present disclosure, a text message analysis request may be input as a text message 1714. A text of “@” in the text message 1714 may be preset to indicate receiver information.

In operation 1630, the electronic device 101 may acquire user schedule information as additional information. For example, the electronic device 101 may acquire user schedule information from a schedule management application. The electronic device 101 may identify a date and time when the user has no schedule using the user schedule information received from the schedule management application. For example, the electronic device 101 may acquire information indicating that dates and times when the user has no schedule are 10:00 to 11:00 A.M. on Nov. 20, Nov. 21, and Nov. 22 as illustrated, for example, in FIG. 17B.

As illustrated in FIG. 16B, in operation 1631, the electronic device 101 may acquire user location information as additional information. For example, the electronic device 101 may acquire user location information from a GPS management application. For example, the electronic device 101 may identify that the location of the user is Gangnam, Seoul. The electronic device 101 may acquire a user location history and may identify that the location of the user on a day and a date with no schedule is Gangnam, Seoul, as illustrated, for example, in FIG. 17B.

In operation 1640, the electronic device 101 may generate a keyword using a natural language analysis result, the user schedule information, and a template. Alternatively, in operation 1641 of FIG. 16B, the electronic device 101 may generate a keyword using a natural language analysis result, the user location information, and a template. For example, as illustrated in FIG. 17B, the electronic device 101 may acquire “to get rid of acne, to cure acne” for an interest item of an item 1721 in a template 1720 as a result of analyzing the text messages. The electronic device 101 may acquire information 1722 on a time, a date, and a location for the item 1721 using the additional information.

In operation 1650, the electronic device 101 may transmit a query including the acquired keyword. In operation 1660, the electronic device 101 may receive an analysis result of the keyword. In operation 1670, the electronic device 101 may operate using the analysis result of the keyword. For example, as illustrated in FIG. 17C, the electronic device 101 may receive and display a keyword analysis result 1715 including an available time for B dermatology clinic. The keyword analysis result 1715 may include, for example, a hyperlink 1716 for booking.

Referring to FIG. 16C, in operation 1610, the electronic device 101 may acquire a plurality of text messages. In operation 1620, the electronic device 101 may perform natural language analysis of each of the plurality of text messages.

In operation 1632, the electronic device 101 may acquire a history associated with a natural language analysis result. For example, it is assumed that the electronic device 101 acquires a keyword of “Nov. 15, movie” as a natural language analysis result as in FIG. 8B. The electronic device 101 may acquire, as a history associated with a keyword of “Nov. 15,” a history indicating that the user has a spare time from 11 A.M. to 3 P.M on Sunday and spends time, usually in Gangnam, Seoul. Further, the electronic device 101 may acquire, as a history associated with a keyword of “movie,” a movie booking history indicating that the user usually watches an action movie.

In operation 1642, the electronic device 101 may generate a keyword using a natural language analysis result, the acquired history, and a template. For example, as illustrated in FIG. 17D, the electronic device 101 may acquire information 1761 of 11 A.M. to 3 P.M., information 865 of Nov. 15, information 1762 of Gangnam, Seoul, and information 1763 of action movie as histories respectively for a time item 863, a date item 864, a location item 866, and an interest item 867. Accordingly, the electronic device 101 may generate a keyword of “Nov. 15, 11 A.M to 3 P.M., Gangnam, Seoul, movie, action movie.” In operation 1650, the electronic device 101 may transmit a query including the acquired keyword. In operation 1660, the electronic device 101 may receive an analysis result of the keyword. In operation 1670, the electronic device 101 may operate using the analysis result of the keyword.

As described above, the electronic device 101 according to various example embodiments of the present disclosure may generate a keyword further using various pieces of additional information, such as user schedule information, user location information, or a history associated with a text analysis result, in addition to the text analysis result.

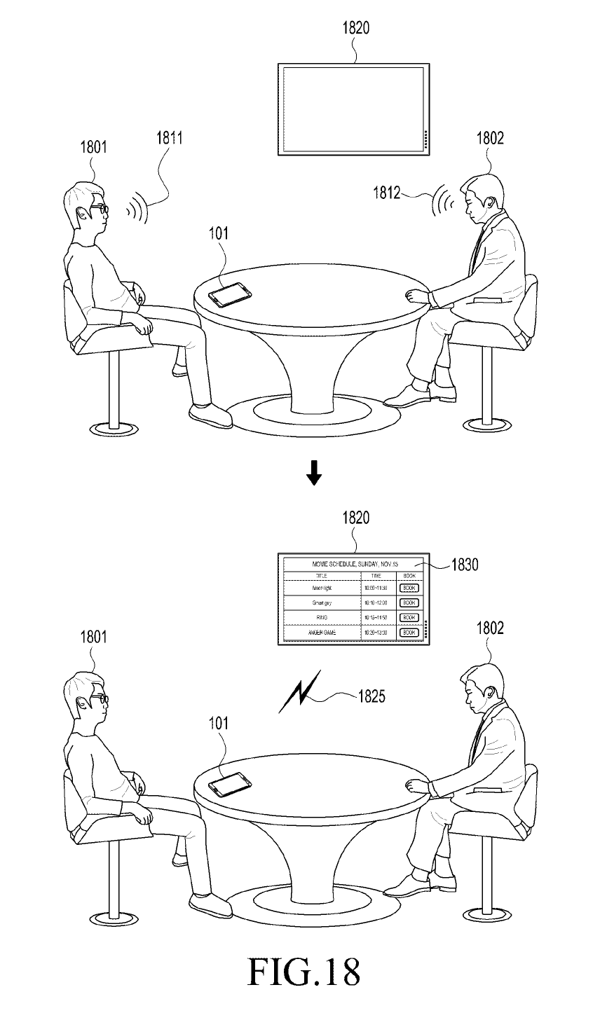

FIG. 18 is a diagram illustrating an operation of an electronic device in an Internet of Things (IoT) environment according to various example embodiments of the present disclosure.

As illustrated in FIG. 18, the electronic device 101 may communicate with another electronic device 1820. In the IoT environment, the electronic device 101 and the other electronic device 1820 may be assigned respective IP addresses in various formats, for example, Ipv4 or Ipv6, and may transmit and receive data using various types of short-range communications (for example, Bluetooth, Bluetooth low energy, Zig-bee, Near Field Communication (NFC), and infrared communication) and the assigned IP addresses. Alternatively, the electronic device 101 may transmit and receive data to and from the other electronic device 1820 based on various communication methods without using an IP address.

In various example embodiments of the present disclosure, the electronic device 101 may include a microphone to acquire an outside voice and a short-range communication module and a cellular module to perform short-range communication with the other electronic device 1820. The electronic device 101 may acquire user voices 1811 and 1812 uttered by persons 1801 and 1802 through the microphone.

The electronic device 101 may perform TTS processing on the user voices 1811 and 1812 to acquire a plurality of text messages corresponding to the user voices 1811 and 1812. The electronic device 101 may process, as one text message, a result of converting user voices successively acquired without a preset pause. In addition, the electronic device 101 may process a user voice using, for example, a voiceprint. For example, even when the two users 1801 and 1802 utter users voices at the same time, the electronic device 101 may separately process the user voices 1811 and 1812, uttered by the respective users 1801 and 1802, using voiceprints. For example, as illustrated in FIG. 5A, the users 1801 and 1802 may utter the user voices 1811 and 1812 having contents of “What are you doing on this Sunday?”, “I don't have special plans.”, “Okay. See a movie?”, “Yes. What movie do you want to see?”, and “Well, what movies are playing now?” The electronic device 101 may perform TTS processing on the user voices 1811 and 1812 to acquire text messages as illustrated in FIG.5A. When a keyword analysis result request is detected, the electronic device 101 may transmit a query including a keyword using an analysis result of the plurality of text messages through the cellular module and may acquire a keyword analysis result as a response to the query.

The electronic device 101 may transmit 1825 the keyword analysis result to the other electronic device 1820 through the short-range communication module. The other electronic device 1820 may display the keyword analysis result 1830 received from the electronic device 101.

In another example embodiment, the electronic device 101 may autonomously perform a keyword analysis and may transmit 1825 a result of the keyword analysis autonomously performed to the other electronic device 1820.

As described above, the electronic device 101 may also perform the transmission of the received keyword analysis result to the other electronic device 1820.

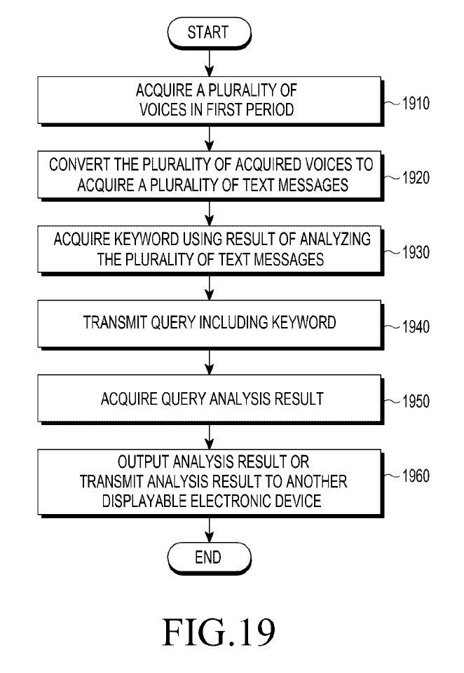

FIG. 19 is a flowchart illustrating an example method of operating an electronic device according to various example embodiments of the present disclosure.

In operation 1910, the electronic device 101 may acquire a plurality of voices in a first period. In operation 1920, the electronic device 101 may convert the plurality of acquired voices to acquire a plurality of text messages. In operation 1930, the electronic device 101 may acquire a keyword using an analysis result of the plurality of text messages.

In operation 1940, the electronic device 101 may transmit a query including the keyword. In operation 1950, the electronic device 101 may acquire an analysis result of the query. In operation 1960, the electronic device 101 may output the analysis result or may transmit the analysis result to another displayable electronic device.

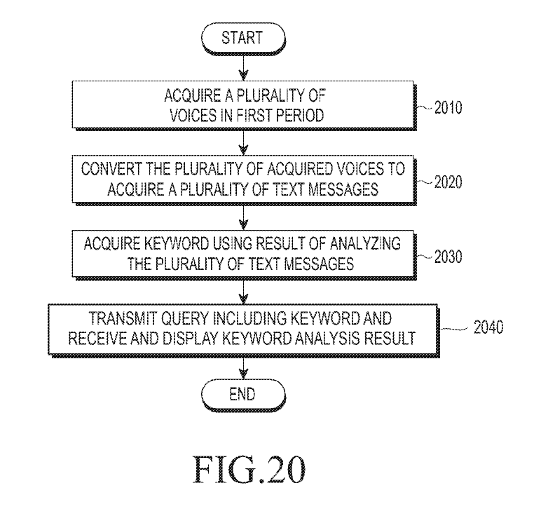

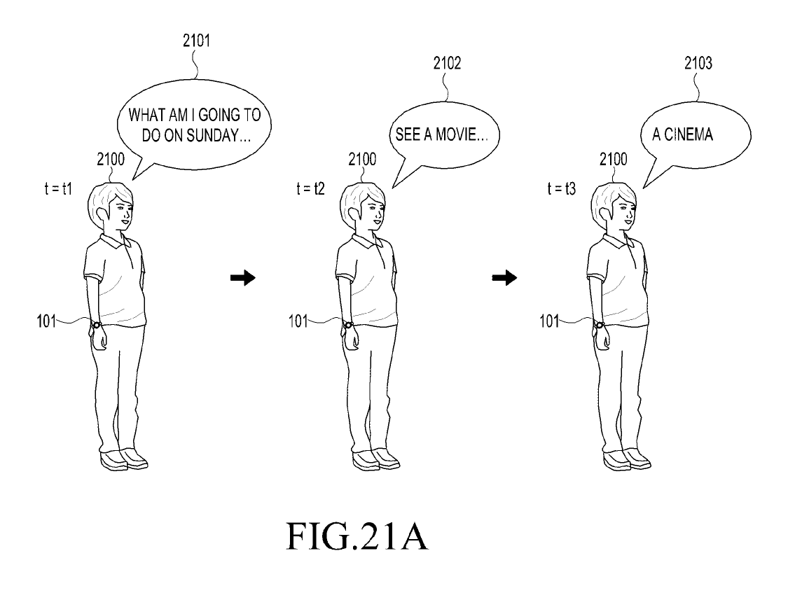

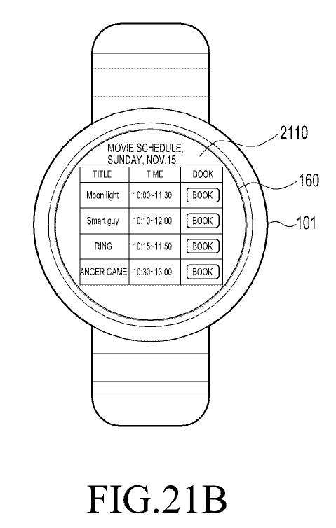

FIG. 20 is a flowchart illustrating an example method of operating an electronic device according to various example embodiments of the present disclosure. The example embodiment of FIG. 20 will be described in greater detail with reference to FIG. 21A and FIG. 21B. FIG. 21A and FIG. 21B are diagrams illustrating an example process of processing a user voice from a single user according to various example embodiments of the present disclosure.

In operation 2010, the electronic device 101 may acquire a plurality of user voices in a first period. For example, as illustrated in FIG. 21A, the electronic device 101 may acquire user voices 2101, 2102, and 2103 respectively at a first time t1, a second time t2, and a third time t3 in the first period. The user voices 2101, 2102, and 2103 may be uttered by a single user 2100. Meanwhile, in FIG. 21, the electronic device 101 may, for example be configured as a watch-type wearable device.

In operation 2020, the electronic device 101 may convert the plurality of acquired voices to acquire a plurality of text messages. When a preset text (for example, @) is included among the plurality of text messages, the electronic device 101 may determine the text as a text message analysis request. When the text message analysis request is detected, the electronic device 101 may acquire a keyword using an analysis result of the plurality of text messages in operation 2030. In operation 2040, the electronic device 101 may transmit a query including the keyword and may receive and display a keyword analysis result. For example, as illustrated in FIG. 21B, the electronic device 101 may display a keyword analysis result 2110 on the display 160. Meanwhile, when the electronic device 101 is configured as a watch-type wearable device, the electronic device 101 may perform the transmission of the query directly to the server (not shown) or the reception of the analysis result directly from the server through the cellular module or may perform the transmission of the query or the reception of the analysis result via another electronic device (for example, a smartphone) through short-range communication.

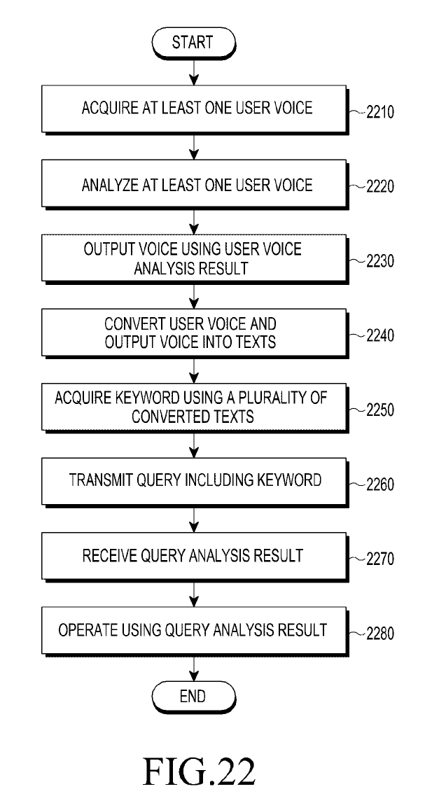

FIG. 22 is a flowchart illustrating an example method of operating an electronic device according to various example embodiments of the present disclosure.

In operation 2210, the electronic device 101 may acquire at least one user voice. In operation 2220, the electronic device 101 may analyze the at least one user voice. In operation 2230, the electronic device 101 may output a voice using an analysis result of the user voice. For example, the electronic device 101 may store a chat algorithm in advance and may output audibly or visually output a text corresponding to a text message of the user voice.

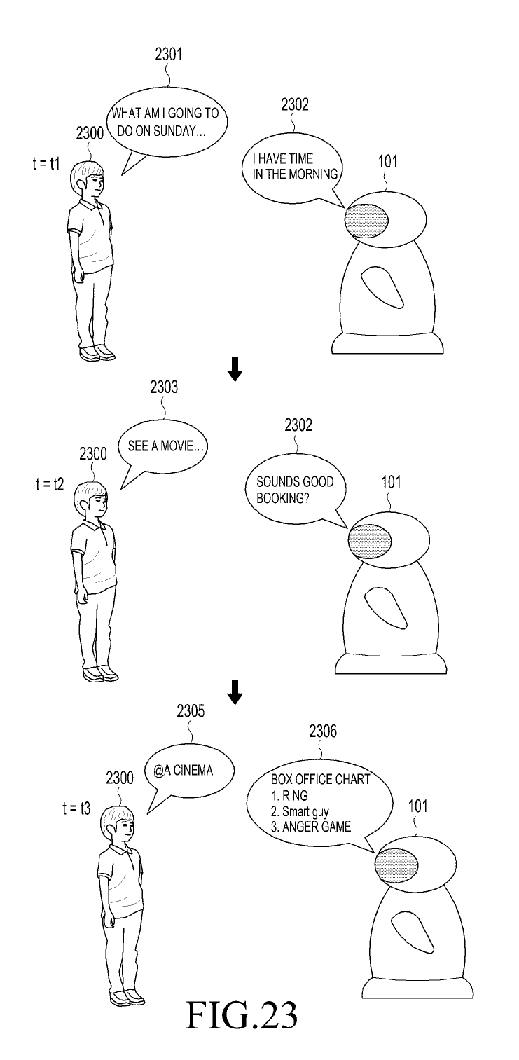

For example, as illustrated in FIG. 23, the electronic device 101 may perform TTS processing on a user voice 2301 uttered by a user 2300 at a first time t1 to acquire a text of “What am I going to do on Sunday?” The electronic device 101 may be configured, for example, as a robot. The electronic device 101 may include a microphone and a speaker. The electronic device 101 may previously store a chat algorithm that is capable of outputting a relevant response to a user-input text. The electronic device 101 may acquire a response of “I have time in the morning” as a result of applying the chat algorithm to the text of “What am I going to do on Sunday?” The electronic device 101 may perform TTS processing on the response of “I have time in the morning” to be output as a voice 2302 or to be output in a visual form through a display (not shown). The electronic device 101 may output the voice 2302, for example, with reference to user schedule information.

The electronic device 101 may also apply the chat algorithm to a user voice 2303 detected at a second time t2 to output a response 2304. The electronic device 101 may acquire a plurality of text messages at the first time t1 and the second time t2. Meanwhile, the electronic device 101 may acquire a voice 2305 including a text message analysis request and receiver information at a third time t3.

In operation 2240, the electronic device 101 may convert the user voice and the output voice into texts. The electronic device 101 may acquire not only a text message received from the user but also a text message output by the electronic device 101. In operation 2250, the electronic device 101 may acquire a keyword using a plurality of converted texts. The electronic device 101 may generate a keyword using both the text message received from the user and the text message output by the electronic device 101. The electronic device 101 may acquire a keyword of “Sunday, A.M., movie,” instead of a keyword of “Sunday, movie,” by using a text message 2302 output by the electronic device 101.

In operation 2260, the electronic device 101 may transmit a query including the keyword. In operation 2270, the electronic device 101 may receive a query analysis result. In operation 2280, the electronic device 101 ay operate using the query analysis result. For example, as illustrated in FIG. 23, the electronic device 101 may output a voice 2306 including the query analysis result.

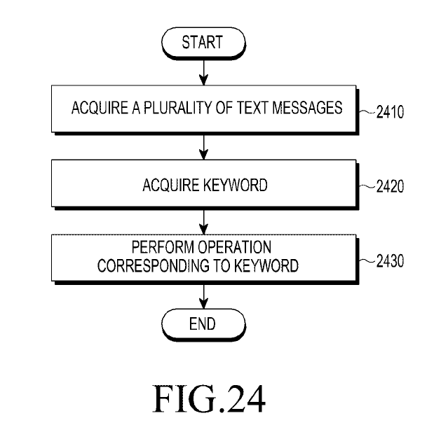

FIG. 24 is a flowchart illustrating an example method of operating an electronic device according to various example embodiments of the present disclosure.

In operation 2410, the electronic device 101 may acquire a plurality of text messages. In operation 2420, the electronic device 101 may analyze the plurality of text messages to acquire a keyword corresponding to the plurality of text messages. A process in which the electronic device 101 acquires a keyword corresponding to a plurality of text messages has been described in detail, and thus a repeated description thereof is omitted herein.

In operation 2430, the electronic device 101 may perform an operation corresponding to the keyword. For example, the electronic device 101 may transmit a query including the keyword corresponding to the keyword. Alternatively, the electronic device 101 may set up a preset operation of inputting the keyword in a web browsing application and displaying a keyword processing result from the web browsing application. The electronic device 101 may store a command corresponding to the keyword in advance and may implement the command or may transmit the command to another electronic device. For example, the electronic device 101 according to various example embodiments of the present disclosure may not only receive an analysis result of the keyword corresponding to the plurality of text messages but may also autonomously perform an operation corresponding to the keyword.

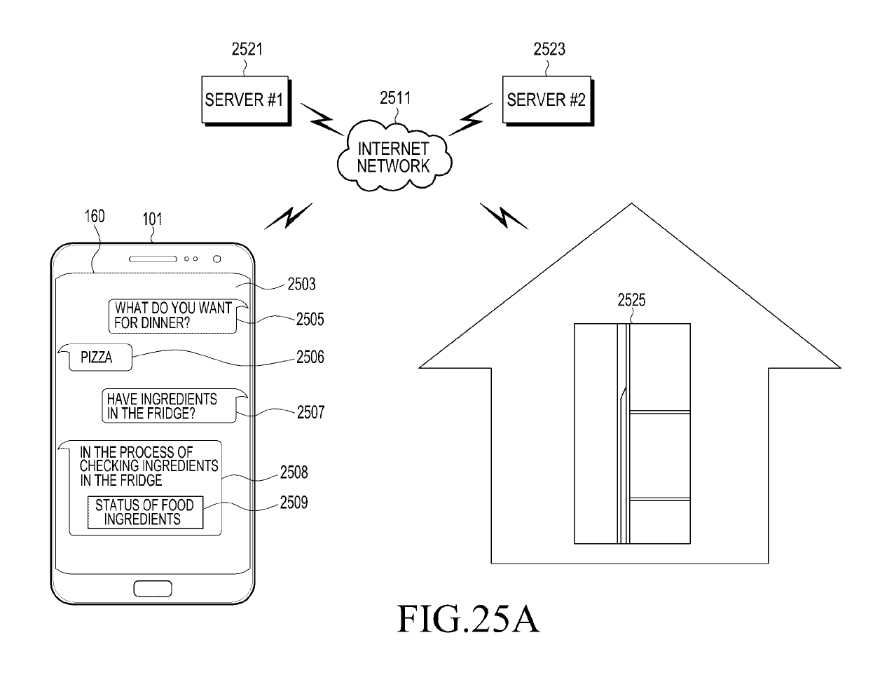

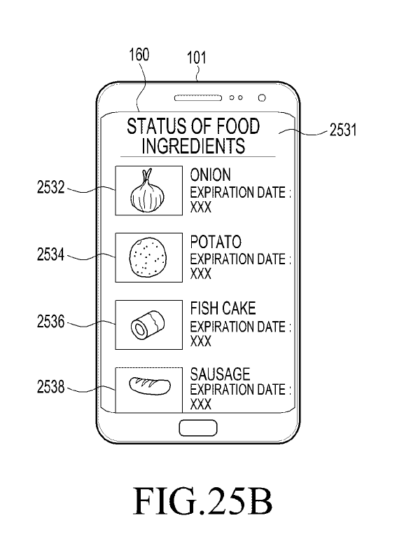

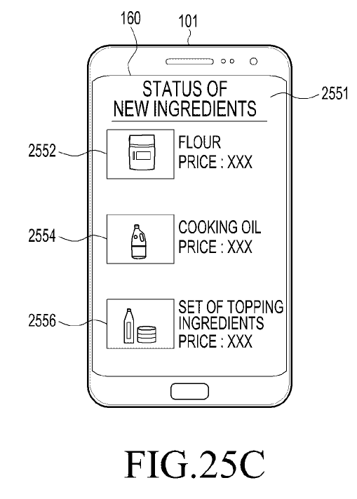

FIG. 25A to FIG. 25C are diagrams illustrating an example case where an electronic device invokes an indoor IoT device and communicates therewith according to various example embodiments of the present disclosure. For the convenience of description, the IoT device is illustrated as a refrigerator, without being limited thereto.

FIG. 25A illustrates the electronic device 101, the IoT device 2525, a first server 2521, and a second server 2523.

The IoT device 2525 may be, for example, a refrigerator installed indoors. The first server 2521 may be, for example, a shopping mall server, without being limited thereto. The second server 2523 may be, for example, a server that manages an indoor IoT device, without being limited thereto.

The electronic device 101 may display an execution screen 2503 of a chat application running in the electronic device on the display 160. The electronic device 101 may display, on the execution screen, a plurality of text messages received from another electronic device through a communication unit and a plurality of text messages input through an input unit of the electronic device. For example, when user A runs the chat application in the electronic device 101, messages 2505, 2506, and 2507 exchanged between user A and user B may be displayed on a screen 2503. User A may input text messages 2505 and 2507 through the input unit of the electronic device. User B may input a text message 2506 through the other electronic device, and the other electronic device may transmit the input text message to the electronic device. The electronic device 101 may display the received text message 2506 on the screen 2503.

The electronic device 101 may determine an external device to provide information for user A based on the plurality of messages displayed on the screen.

The electronic device 101 may acquire the plurality of text messages 2505, 2506, and 2507 through the chat application. The electronic device 101 may extract a keyword from the plurality of text messages 2505, 2506, and 2507 and may be provided with information from the external device based on the extracted keyword. The electronic device 101 may transmit and receive data to and from the external device in order to be provided with information from the external device. Methods in which the electronic device 101 extracts a keyword from a text message and disposes and displays a text message on a screen have been described in FIG. 4 to FIG. 10, and thus detailed repeated descriptions thereof are omitted.

The external device may be the first server 2521, the second server 2523, or the refrigerator 2525.

For example, when user A asks user B “What do you want to eat for dinner?” 2505 and user B replies “Pizza” 2506, the electronic device 101 may determine that the two people are having a conversation about food from the words “dinner,” “eat,” and “pizza” and may retrieve a food-related device among IoT devices installed indoors.

The electronic device may receive information from a determined external device. The food-related device may be, for example, a refrigerator or Micro Wave Oven (MWO). When user A inputs a message of “Have ingredients in the fridge?,” the electronic device 101 may extract keywords of “fridge” and “ingredients” from the message and may check an inventory of food ingredients stored in the refrigerator. For example, the electronic device 101 may retrieve an external device to transmit and receive data to and from based on a word (keyword) extracted from the plurality of text messages 2505, 2506, and 2507 and may transmit and receive data to and from the retrieved external device. For example, the data may be a command to control the external device or data to be provided to the external device.

The electronic device 101 may request an inventory of ingredients from the refrigerator 2525 based on the text message 2507 and may display a message 2508 related to the request on the screen. The electronic device 101 may receive “the inventory of food ingredients” from the refrigerator 2525 and may display the received inventory of food ingredients on the screen 2503 on which the application is running. Here, the plurality of text messages 2505, 2506, and 2507 and the information 2508 received from the refrigerator may be chronologically arranged and displayed on the execution screen.

The electronic device 101 may display a UI element 2509 within the text message 2508 in order to provide information on the inventory of food ingredients in the refrigerator 2525. The UI element 2509 may be a button. The UI element may receive a user input.

When user A selects the button 2509, the inventory of food ingredients in the refrigerator may be displayed on the screen. The inventory of food ingredients may be displayed within the text message 2508 or be displayed on a separate pop-up window, without being limited thereto. For example, the inventory of food ingredients may be provided by a voice guidance.

In an example embodiment, the electronic device 101 may receive the inventory of food ingredients in the refrigerator 2525 through the second server 2523. The second server 2523 may be a server that manages an indoor IoT device, may manage data on the state and condition of the indoor IoT device in a database form, and may transmit the data on the indoor IoT device to another device including the electronic device 101.

Referring to FIG. 25B, the electronic device 101 may display the inventory of food ingredients 2531 on the screen according to a user input of selecting the button 2509 illustrated in FIG. 25A. On the screen of the inventory of food ingredients 2531, food ingredient images 2532, 2534, 2536, and 2538 and the names and expiration dates of food ingredients may be displayed.

The food ingredient images 2532, 2534, 2536, and 2538 may be acquired through a camera mounted on the refrigerator or through the first server (shopping mall server) 2521. The names and expiration dates of food ingredients may be acquired through the first server 2521.

The electronic device 101 may check an inventory of ingredients to be additionally purchased based on the text message and may provide the inventory of ingredients to the user.

Referring to FIG. 25C, the electronic device may display an inventory of new ingredients 2551 to be purchased on the screen. The electronic device 101 may extract a keyword of “pizza” from the text message 2506 in FIG. 25A and may retrieve a recipe for “pizza” through the first server. The electronic device 101 may compare necessary food ingredients for “pizza” and the inventory of food ingredients in the refrigerator based on a retrieval result and may generate the inventory of new ingredients 2551 to be purchased.

The inventory of new ingredients 2551 to be purchased may include food ingredient images 2552, 2554, and 2556 and the names and prices of food ingredients. The electronic device 101 may transmit information on food ingredients included in the inventory of new ingredients 2551 to be purchased to the first server (shopping mall server) 2521 through user's confirmation. For example, the electronic device 101 may order the new ingredients to be purchased through user's confirmation.

In an example embodiment, the electronic device 101 may automatically order food ingredients by referring to the inventory of new ingredients 2551 to be purchased, without user's confirmation.

In various example embodiments of the present disclosure, a method of operating an electronic device may include: acquiring a plurality of text messages; acquiring a keyword corresponding to the plurality of text messages by analyzing each of the plurality of text messages; transmitting a query including the keyword to an external device; and performing an operation corresponding to an analysis result of the keyword after receiving the analysis result of the keyword.

In various example embodiments of the present disclosure, the method may further include acquiring receiver information on a receiver that performs a keyword analysis, wherein the transmitting of the query transmits the query including the keyword and the receiver information, and the keyword analysis is performed by an electronic device corresponding to the receiver information.

In various example embodiments of the present disclosure, the acquiring of the keyword may include: performing natural language processing on each of the plurality of text messages; and generating the keyword using a natural language processing result of each of the plurality of text messages.

In various example embodiments of the present disclosure, the generating of the keyword using the natural language processing result of each of the plurality of text messages may include: comparing a preset template with the natural language processing result; and generating the keyword based on a comparison result.

In various example embodiments of the present disclosure, the generating of the keyword using the natural language processing result of each of the plurality of text messages may include: applying a machine learning or deep learning algorithm to the natural language processing result; determining the intent of each of the plurality of text messages based on an application result; and generating the keyword based on the intent of each of the plurality of text messages.

In various example embodiments of the present disclosure, the acquiring of the plurality of text messages may include: acquiring a plurality of first text messages in a first period; and acquiring a plurality of second text messages in a second period.

In various example embodiments of the present disclosure, the acquiring of the keyword may include: generating a first keyword corresponding to the plurality of first text messages; and generating a second keyword corresponding to the plurality of second text messages.

In various example embodiments of the present disclosure, the generating of the second keyword may include generating the second keyword using an analysis result of the plurality of second text messages and at least one of the first keyword and the plurality of first text messages.

In various example embodiments of the present disclosure, the method may further include acquiring additional information, wherein the acquiring of the keyword may include generating the keyword using an analysis result of the plurality of text messages and the additional information.

In various example embodiments of the present disclosure, the acquiring of the additional information may include acquiring additional information associated with the analysis result of the plurality of text messages or may acquire independent additional information from the plurality of text messages.

In various example embodiments of the present disclosure, the acquiring of the plurality of text messages may include: acquiring a plurality of user voices; and acquiring the plurality of text messages by converting the plurality of user voices.

In various example embodiments of the present disclosure, a method of operating an electronic device may include: displaying an execution screen of a chat application running in the electronic device; displaying a plurality of text messages input to the electronic device or received from another electronic device, on the execution screen of the chat application; receiving an analysis request for the plurality of text messages; transmitting a keyword corresponding to the plurality of text messages upon the analysis request; and receiving an analysis result of the keyword and displaying the received analysis result of the keyword on the execution screen of the chat application.

In various example embodiments of the present disclosure, a method of operating an electronic device may include: acquiring a plurality of text messages; acquiring a keyword corresponding to the plurality of text messages by analyzing each of the plurality of text messages; and performing an operation corresponding to the keyword.

Each of the components of the electronic device according to the present disclosure may be implemented by one or more components and the name of the corresponding component may vary depending on a type of the electronic device. In various example embodiments, the inspection apparatus may include at least one of the above-described elements. Some of the above-described elements may be omitted from the electronic device, or the inspection apparatus may further include additional elements. Further, some of the components of the electronic device according to the various example embodiments of the present disclosure may be combined to form a single entity, and thus, may equivalently execute functions of the corresponding elements prior to the combination.

The term “module” as used herein may, for example, refer to a unit including one of hardware (e.g., circuitry), software, and firmware or a combination of two or more of them. The “module” may be interchangeably used with, for example, the term “unit”, “logic”, “logical block”, “component”, or “circuit”. The “module” may be the smallest unit of an integrated component or a part thereof. The “module” may be the smallest unit that performs one or more functions or a part thereof. The “module” may be mechanically or electronically implemented. For example, the “module” according to the present disclosure may include at least one of processing circuitry, an Application-Specific Integrated Circuit (ASIC) chip, a Field-Programmable Gate Arrays (FPGA), and a programmable-logic device for performing operations which has been known or are to be developed hereinafter.

According to various example embodiments, at least some of the devices (for example, modules or functions thereof) or the method (for example, operations) according to the present disclosure may be implemented by a command stored in a computer-readable storage medium in a programming module form. When the command is executed by one or more processors (for example, the processor 120), the one or more processors may execute a function corresponding to the command. The computer-readable storage medium may, for example, be the memory 130.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various example embodiments of the present disclosure may be executed sequentially, in parallel, repeatedly, or in a heuristic manner. Further, some operations may be executed according to another order or may be omitted, or other operations may be added.

According to various example embodiments of the present disclosure, a storage medium stores commands, wherein the commands are set for at least one processor to perform at least one operation when executed by the at least one processor, and the at least one operation may include: acquiring a plurality of text messages; acquiring a keyword corresponding to the plurality of text messages by analyzing each of the plurality of text messages; transmitting a query including the keyword; and performing an operation corresponding to an analysis result of the keyword after receiving the analysis result of the keyword.

Various example embodiments disclosed herein are provided merely to easily describe technical details of the present disclosure and to aid in understanding of the present disclosure, and are not intended to limit the scope of the present disclosure. Therefore, it should be understood that all modifications and changes or modified and changed forms based on the technical idea of the present disclosure fall within the scope of the present disclosure.

What is claimed is:

1. A method of operating an electronic device comprising:
acquiring a plurality of text messages;
acquiring a keyword corresponding to the plurality of text messages by analyzing each of the plurality of text messages;
transmitting a query comprising the keyword to an external device; and
performing an operation corresponding to the analysis result of the keyword after receiving the analysis result of the keyword.

2. The method of claim 1, further comprising acquiring receiver information on a receiver that performs a keyword analysis, wherein the transmitting of the query includes transmitting the query comprising the keyword and the receiver information, and the keyword analysis is performed by an electronic device corresponding to the receiver information.

3. The method of claim 1, wherein the acquiring of the keyword comprises:
performing natural language processing on each of the plurality of text messages; and
generating the keyword using a natural language processing result of each of the plurality of text messages.

4. The method of claim 3, wherein the generating of the keyword using the natural language processing result of each of the plurality of text messages comprises:
comparing a preset template with the natural language processing result; and
generating the keyword based on a comparison result.

5. The method of claim 3, wherein the generating of the keyword using the natural language processing result of each of the plurality of text messages comprises:
applying one of a machine learning or deep learning algorithm to the natural language processing result;
determining an intent of each of the plurality of text messages based on a result of applying one of the machine learning or deep learning algorithm; and
generating the keyword based on the intent of each of the plurality of text messages.

6. The method of claim 1, wherein the acquiring of the plurality of text messages comprises:
acquiring a plurality of first text messages in a first period; and
acquiring a plurality of second text messages in a second period.

7. The method of claim 6, wherein the acquiring of the keyword comprises:
generating a first keyword corresponding to the plurality of first text messages; and
generating a second keyword corresponding to the plurality of second text messages.

8. The method of claim 7, wherein the generating of the second keyword includes generating the second keyword using an analysis result of the plurality of second text messages and at least one of the first keyword and the plurality of first text messages.

9. The method of claim 1, further comprising acquiring additional information, wherein the acquiring of the keyword includes generating the keyword using an analysis result of the plurality of text messages and the additional information.

10. The method of claim 9, wherein the acquiring of the additional information includes acquiring additional information associated with the analysis result of the plurality of text messages or acquiring independent additional information from the plurality of text messages.

11. The method of claim 1, wherein the acquiring of the plurality of text messages comprises:
acquiring a plurality of user voices; and
acquiring the plurality of text messages by converting the plurality of user voices into text.

12. An electronic device comprising:
a communication module comprising communication circuitry;
a processor comprising processing circuitry that is electrically connected to the communication circuitry of the communication module; and
a memory that is electrically connected to the processor,
wherein the memory stores an instruction for the processor, which, when executed by processing circuitry of the processor, causes the processor to perform operations comprising, acquiring a plurality of text messages, acquiring a keyword corresponding to the plurality of text messages by analyzing each of the plurality of text messages, transmitting a query comprising the keyword to an external device using the communication circuitry of the communication module, and performing an operation corresponding to an analysis result of the keyword after receiving the analysis result of the keyword.

13. The electronic device of claim 12, wherein the memory stores an instruction for the processor, which, when executed by the processing circuitry, causes the processor to perform further operations comprising, acquiring receiver information on a receiver that performs a keyword analysis and transmitting the query comprising the keyword and the receiver information using the communication circuitry of the communication module, and an electronic device corresponding to the receiver information is configured to perform the keyword analysis.

14. The electronic device of claim 12, wherein the memory stores an instruction for the processor, which, when executed by the processing circuitry, causes the processor perform further operations comprising, performing natural language processing on each of the plurality of text messages and generating the keyword using a natural language processing result of each of the plurality of text messages.

15. The electronic device of claim 14, wherein the memory stores an instruction for the processor, which when executed by the processing circuitry, causes the processor to perform further operations comprising, comparing a preset template with the natural language processing result and generating the keyword based on a comparison result.

16. The electronic device of claim 14, wherein the memory stores an instruction for the processor, which when executed by the processing circuitry, causes the processor to perform further operations comprising, applying a machine learning or deep learning algorithm to the natural language processing result to determine intent of each of the plurality of text messages based on a result of applying the machine learning or deep learning algorithm, and generating the keyword based on the intent of each of the plurality of text messages.

17. The electronic device of claim 12, wherein the memory stores an instruction for the processor, which when executed by the processing circuitry, causes the processor to perform further operations comprising, acquiring a plurality of first text messages in a first period and acquiring a plurality of second text messages in a second period.

18. A method of operating an electronic device comprising:
displaying, on a display, an execution screen of a chat application running on the electronic device;
displaying, on the execution screen, a plurality of text messages received from another electronic device through communication circuitry of a communication unit and a plurality of text messages input through input circuitry of an input unit of the electronic device;
determining an external device that is capable of providing information based on at least one of the plurality of text messages displayed on the execution screen;
receiving information from the determined external device; and
displaying the received information on the display.

19. The method of claim 18, wherein the plurality of text messages displayed on the execution screen and the received information are chronologically arranged and displayed on the execution screen.

20. The method of claim 18, wherein a user interface (UI) capable of receiving an input is displayed on the execution screen.
